(19) United States
(12) Patent Application Publication
(10) Pub. No.: US 2026/0292866 A1
(43) Pub. Date: Sep. 24, 2026

(54) MAC-CE ENCODING BASED ON CONTENT PRIORITY

(71) Applicant: QUALCOMM Incorporated, San Diego, CA (US)

(72) Inventors: Sitaramanjaneyulu KANAMARLAPUDI, San Diego, CA (US); Linhai HE, San Diego, CA (US); Jelena DAMNJANOVIC, Del Mar, CA (US); Doohyun SUNG, Basking Ridge, NJ (US)

(21) Appl. No.: 19/088,738

(22) Filed: Mar. 24, 2025

(51) Int. Cl. H04W 72/566; H04W 72/231

(52) U.S. Cl. CPC H04W 72/566; H04W 72/231

(57) ABSTRACT

A method for wireless communication at a user equipment (UE) and related apparatus are provided. In the method, the UE receives a grant of uplink resources, and prioritizes, for each medium access control-control element (MAC-CE) of one or more MAC-CEs, different portions of the MAC-CE based on respective content of respective portions of the MAC-CE. Different content within the MAC-CE is associated with a separate priority level. The UE further transmits the one or more MAC-CEs to a network entity based on the uplink resources and the priority levels of the different portions of each MAC-CE of the one or more MAC-CEs.

### TECHNICAL FIELD

The present disclosure relates generally to communication systems and, more particularly, to wireless communication that includes a medium access control-control element (MAC-CE).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard, and some aspects of future wireless communication technologies may be based on aspects of 5G NR. There exists a need for further improvements in 5G NR technology and future wireless communication technologies, such as 6G, among other examples. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor may be configured to receive a grant of uplink resources; prioritize, for each MAC-CE of one or more MAC-CEs, different portions of the MAC-CE based on respective content of respective portions of the MAC-CE, where different content within the MAC-CE is associated with a separate priority level; and transmit, to a network entity, based on the uplink resources and the priority levels of the different portions of each MAC-CE of the one or more MAC-CEs, the one or more MAC-CEs.

In an aspect of the disclosure, a method, a computer-readable medium, and an apparatus are provided for wireless communication at a UE. The apparatus may include at least one memory and at least one processor coupled to the at least one memory. Based at least in part on information stored in the at least one memory, the at least one processor may be configured to receive a grant of uplink resources; prioritize multiple candidate MAC-CEs based on multiple priority classes; prioritize one or more candidate MAC-CEs within a priority class of the multiple priority classes; and transmit, to a network entity, based on the uplink resources and the multiple priority classes, one or more selected MAC-CEs from the one or more candidate MAC-CEs in the priority class.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor may be configured to configure a grant of uplink resources for a UE; and receive, from the UE, based on the uplink resources, contents from one or more MAC-CEs according to multiple priority levels of the contents within each MAC-CE of the one or more MAC-CEs, where different content within the MAC-CE is associated with a separate priority level of the multiple priority levels.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A is a diagram illustrating an example of a downlink medium access control (MAC) protocol data unit (PDU).

FIG. 4B is a diagram illustrating an example of an uplink MAC PDU.

FIG. 5 is a diagram illustrating examples of the contents included in MAC-CEs.

FIG. 6 is a diagram illustrating a medium access control-control element (MAC-CE) prioritization method in accordance with various aspects of the present disclosure.

FIG. 7 is a diagram illustrating a content-based MAC-CE prioritization method in accordance with various aspects of the present disclosure.

FIG. 8 is a call flow diagram illustrating a method of wireless communication in accordance with various aspects of the present disclosure.

FIG. 9 is a flowchart illustrating methods of wireless communication at a UE in accordance with various aspects of the present disclosure.

FIG. 10 is a flowchart illustrating methods of wireless communication at a UE in accordance with various aspects of the present disclosure.

FIG. 11 is a flowchart illustrating methods of wireless communication at a UE in accordance with various aspects of the present disclosure.

FIG. 12 is a flowchart illustrating methods of wireless communication at a UE in accordance with various aspects of the present disclosure.

FIG. 13 is a flowchart illustrating methods of wireless communication at a network entity in accordance with various aspects of the present disclosure.

FIG. 14 is a diagram illustrating an example of a hardware implementation for an example apparatus and/or UE.

FIG. 15 is a diagram illustrating an example of a hardware implementation for an example network entity.

FIG. 16 is an illustrative block diagram of an example machine learning (ML) model represented by an artificial neural network (ANN), in accordance with various aspects of the present disclosure.

### DETAILED DESCRIPTION

In wireless communication, medium access control (MAC)-control elements (MAC-CEs) are a part of a MAC procedure to convey information more quickly compared to upper-layer protocols such as radio resource control (RRC) signaling for control plane information or radio link control (RLC) and packet data convergence protocol (PDCP) for data plane information. MAC-CEs may be used for various purposes across different procedural layers and may be assigned a priority level relative to other MAC-CEs. When the allocated grant is insufficient to transmit all the MAC-CEs, transmission or truncation of the MAC-CEs may be determined based on their priority levels, e.g., a priority level associated with the MAC-CE. However, the such a prioritization mechanism assigns a single priority level to an entire MAC-CE without considering the possible varying importance of the individual elements (e.g., different content) within a particular MAC-CE. As a result, some important information in a lower-priority MAC-CE may be delayed or omitted, adversely impacting wireless communication. Example aspects presented herein provide methods and apparatus that enable the consideration of additional priority levels for each element (e.g., different content) within a MAC-CE, enabling a more refined approach to truncation when transmission resources are limited. The prioritization based on separate content within a MAC-CE, as presented herein, helps to ensure that higher-priority elements are transmitted in a timely manner.

Various aspects relate generally to wireless communication. Some aspects more specifically relate to the design of MAC-CEs in wireless communication. In some examples, a UE receives a grant of uplink resources from a network entity. The UE then prioritizes, for each MAC-CE of one or more MAC-CEs, different portions of the MAC-CE based on respective content of respective portions of the MAC-CE. Different content within the MAC-CE is associated with a separate priority level. The UE then transmits the one or more MAC-CEs to the network entity based on the uplink resources and the priority levels of the different portions of each MAC-CE of the one or more MAC-CEs. In some examples, the priority levels for the respective content of the MAC-CE may be based on one or more of: logic channel group (LCG) information of the respective content of the MAC-CE, service beam information of the respective content of the MAC-CE, or cell information of the respective content of the MAC-CE. In some examples, the UE may transmit a combination of contents respectively from multiple MAC-CEs based on the priority levels of the different portions of each MAC-CE of the one or more MAC-CEs. In some examples, the UE may prioritize multiple candidate MAC-CEs based on multiple priority classes, and prioritize one or more candidate MAC-CEs within a priority class of the multiple priority classes. In some examples, the UE may prioritize one or more candidate MAC-CEs within a priority class of the multiple priority classes based on a content selection criterion. The content selection criterion may be a defined rule, a signaling from the network entity, or the implementation of the UE.

Particular aspects of the subject matter described in this disclosure can be implemented to realize one or more of the following potential advantages. In some examples, by enabling content-based prioritization across different MAC-CEs, the described techniques help to reduce delay for high-priority contents from lower-priority MAC-CEs and reduce the risk of missing important information in the MAC-CEs when transmission resources are limited. In some examples, by allowing MAC-CE prioritization to be configured through standards, signaling, or UE implementation, the described techniques provide flexibility in adapting prioritization strategies based on real-time network conditions and use cases. In some examples, by introducing multiple priority classes instead of relying solely on absolute priority order among the MAC-CEs, the described techniques improve scheduling efficiency, and the efficiency and timeliness of MAC-CE transmissions.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, 6G systems, or other communication systems, may be arranged in multiple manners with various components or constituent parts. As an example, in a wireless communication network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

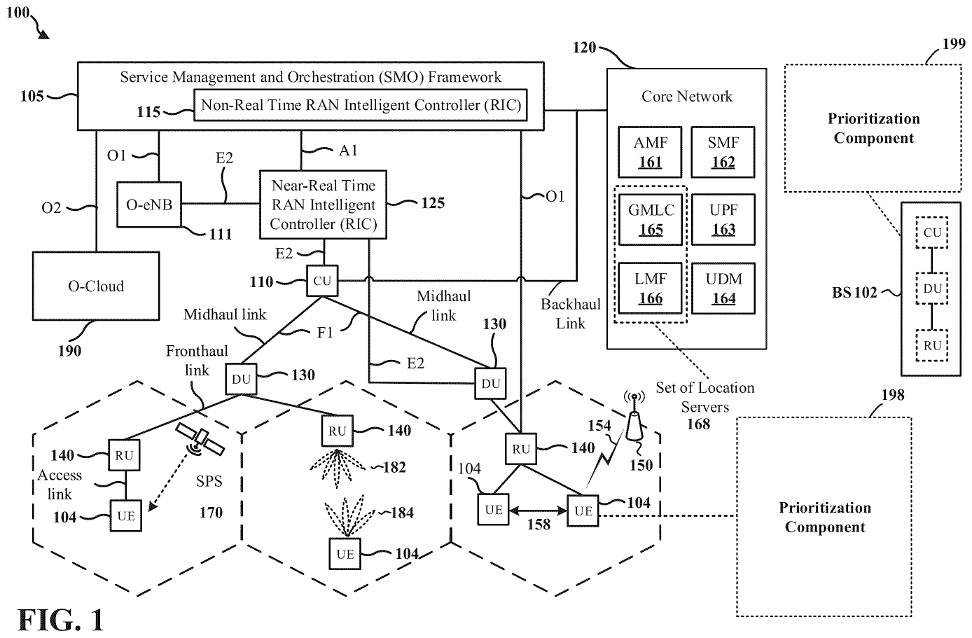

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. As an example, to illustrate the concept, in 5G NR, two initial operating bands have been identified as frequency range designations FR1 (410 MHz-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. An operating band for these mid-band frequencies may have the frequency range designation FR3 (7.125 GHZ-24.25 GHZ), for example. Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation, or other wireless communication operation, beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

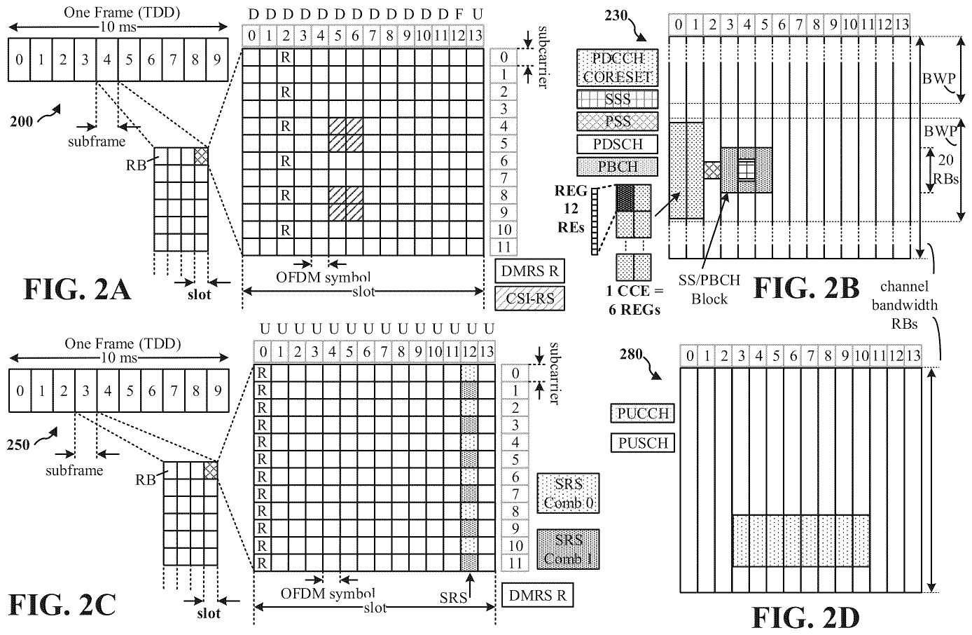

Referring again to FIG. 1, in certain aspects, the UE 104 may include the prioritization component 198. In some aspects, the prioritization component 198 may be configured to receive a grant of uplink resources; prioritize, for each MAC-CE of one or more MAC-CEs, different portions of the MAC-CE based on respective content of respective portions of the MAC-CE, where different content within the MAC-CE is associated with a separate priority level; and transmit, to a network entity, based on the uplink resources and the priority levels of the different portions of each MAC-CE of the one or more MAC-CEs, the one or more MAC-CEs. In some aspects, the prioritization component 198 may be configured to receive a grant of uplink resources; prioritize multiple candidate MAC-CEs based on multiple priority classes; prioritize one or more candidate MAC-CEs within a priority class of the multiple priority classes; and transmit, to a network entity, based on the uplink resources and the multiple priority classes, one or more selected MAC-CEs from the one or more candidate MAC-CEs in the priority class. In certain aspects, the base station 102 may include the prioritization component 199. The prioritization component 199 may be configured to configure a grant of uplink resources for a UE; and receive, from the UE, based on the uplink resources, contents from one or more MAC-CEs according to multiple priority levels of the contents within each MAC-CE of the one or more MAC-CEs. Different content within the MAC-CE may be associated with a separate priority level of the multiple priority levels. Although the following description may be focused on 5G NR, the concepts described herein may be applicable to other similar areas, such as LTE, LTE-A, CDMA, GSM, and other wireless technologies. FIG. 2A is a diagram 200 illustrating an example of a first subframe within a 5G NR frame structure. The examples in FIGS. 2A-2D, illustrate aspects of a frame structure based on 5G NR to illustrate the concept of time and frequency resources based on a frame structure. Similar aspects may be used in connection with other technology, such as 6G, for example. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

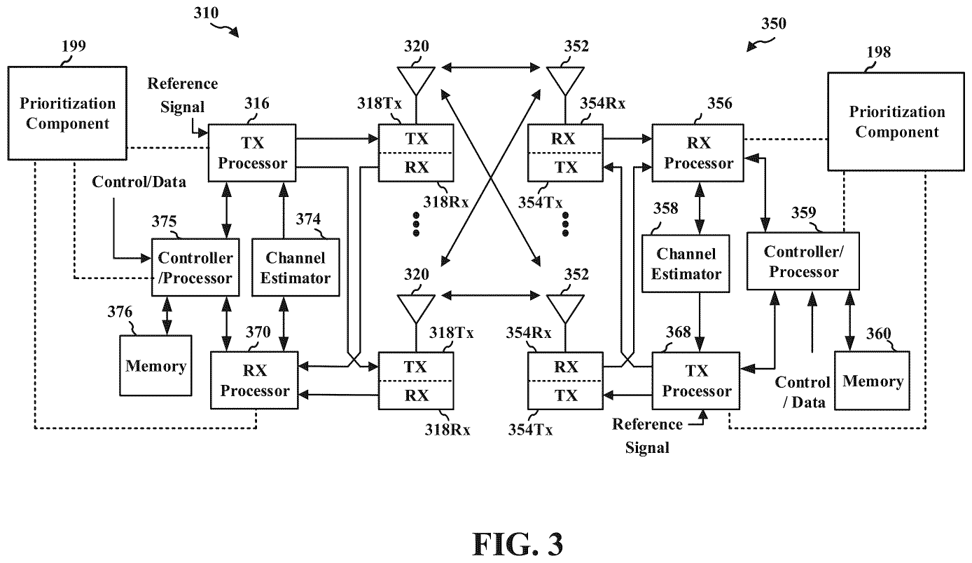

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the prioritization component 198 of FIG. 1.

At least one of the TX processor 316, the RX processor 370, and the controller/processor 375 may be configured to perform aspects in connection with the prioritization component 199 of FIG. 1.

In wireless communication, MAC-CEs are part of the MAC procedure to convey information more quickly compared to upper-layer protocols such as RRC for control plane information or RLC and PDCP for data plane information. MAC-CEs may be used for multiple purposes across different procedural layers. For example, in the control plane, MAC-CEs may be used for procedures such as secondary cell (SCell) activation and deactivation, component carrier (CC) activation and deactivation, triggering of lower-layer triggered mobility (LTM), discontinuous reception (DRX) configuration, recommended bitrate signaling, and beam failure recovery (BFR), which may otherwise be handled using the RRC level procedure. In the data plane, MAC-CEs may be used for procedures such as buffer status reporting (BSR), dynamic scheduling requests (DSR), and RLC duplication control, which may otherwise be handled using the data plane (RLC/PDCP) level procedures. In the physical (PHY) plane, MAC-CEs may be used for procedures such as power headroom reporting (PHR), timing advance commands, and activation or deactivation of channel state information-reference signals (CSI-RS) and interference measurement (IM), transmission configuration indicator (TCI) state, and sounding reference signals (SRS).

MAC-CEs assist in closed-loop coordination for wireless communication as MAC-CEs are encoded during MAC transport block (MAC-TB) encoding. This encoding process represents real-time information exchange (e.g., indication and command) regarding the transmitting entity, and provides quick real-time activation or deactivation decisions from the receiver, thereby avoiding multi-layer processing delays and transmission delays associated with distributed unit (DU) and central unit (CU) links.

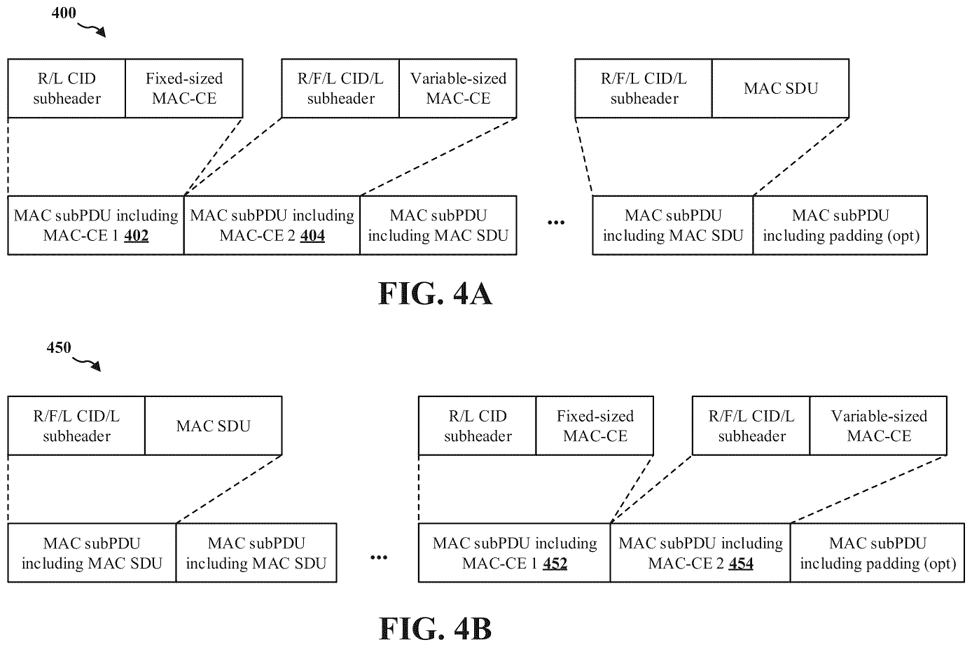

The length of a MAC-CE may vary depending on the nature of the information that the MAC-CE carries, or a type of the MAC-CE. For example, a MAC-CE including a BSR report may cover all the logical channel groups (LCGs) having non-zero data, a MAC-CE for multiple-entry PHR may include power headroom values for multiple TRPs, a MAC-CE for an enhanced SCell activation or deactivation may include information for each individual SCell, and a MAC-CE for TCI state activation or deactivation may include a unified TCI state activation or deactivation information. FIG. 4A is a diagram illustrating an example of a downlink medium access control (MAC) protocol data unit (PDU). In FIG. 4A, the downlink MAC PDU 400 may include multiple MAC-CEs, such as MAC-CE 1 402, MAC-CE 2 404. For example, MAC-CE 1 402 may be a fixed-size MAC-CE, and MAC-CE 2 404 may be a variable-sized MAC-CE. FIG. 4B is a diagram illustrating an example of an uplink MAC PDU. In FIG. 4B, the uplink MAC PDU 450 may include multiple MAC-CEs, such as MAC-CE 1 452, MAC-CE 2 454. For example, MAC-CE 1 452 may be a fixed-size MAC-CE, and MAC-CE 2 454 may be a variable-sized MAC-CE. Since the uplink MAC-TB (e.g., MAC PDU 450) is based on the grant allocated by the network, and the downlink MAC-TB (e.g., MAC PDU 400) is based on the scheduling resources assigned by the network, it is not always feasible to encode all the triggered MAC-CEs with full information into an uplink MAC-TB (e.g., MAC PDU 450) due to the varying lengths.

In some examples, each MAC-CE type may be provided with, or be associated with, a priority level (e.g., an absolute priority) relative to other types of MAC-CEs, and the MAC-CE transmission may be truncated based on the priority of the MAC-CEs when necessary. For example, during a MAC-CE truncation (e.g., when there are not enough allocated resources to transmit all of the MAC-CEs), one or more lower-priority MAC-CE types may be removed or omitted from a MAC PDU (e.g., MAC PDU 450). For example, when there is not enough transmission resource (e.g., not enough bytes) to include all the scheduled or triggered MAC-CEs, the UE may skip, drop, omit, or delay transmission of at least one of the scheduled/triggered MAC-CEs based on a prioritization among MAC-CE types. Thus, the prioritization is at the level of a MAC-CE by comparing one MAC-CE type to another MAC-CE type. In some examples, a skipped MAC-CE may be transmitted in a later uplink transmission if it cannot be transmitted within the current grant.

In some examples, the allocated grant may not be sufficient to transmit all the MAC-CEs, for example, in challenging conditions such as when a UE is at the edge of the cell, and the UE may truncate one or more MAC-CEs. The truncation may be based on the absolute priority of one MAC-CE relative to another MAC-CE, e.g., without consideration of the relative priority of the contents within each MAC-CE, when determining what to transmit in scenarios where the available grant (or number of bits) is insufficient to accommodate all information within the same MAC-TB.

As an example, logical channel prioritization may prioritize MAC-CE types in the order shown in Table 2, where the highest priority MAC-CE types are listed first:

TABLE 2
Priorities of MAC-CE types
Logical Channel Prioritization for MAC-CE Types
(highest priority listed first)

MAC-CEs for cell radio network temporary identifier (C-RNTI),
MAC-CEs for data from the uplink common control channel (UL-CCCH)
MAC-CEs for beam failure recovery (BFR) or enhanced BFR
MAC-CEs for configured grant confirmation, or multiple entry configured
grant confirmation
MAC-CEs for sidelink configured grant confirmation
MAC-CEs for listen-before-talk (LBT) failure
MAC-CEs for timing advance report
MAC-CEs for sidelink buffer status report (SL-BSR)
MAC-CEs for BSR or extended BSR (except the BSR included for
padding)
MAC-CEs for (enhanced) single entry PHR or (enhanced) multiple entry
PHR
MAC-CEs for positioning measurement gap activation/deactivation request
MAC-CEs for the number of desired guard symbols
MAC-CEs for Case-6 timing request
MAC-CE for (extended) pre-emptive BSR
MAC-CEs for SL-BSR (e.g., with the exception of some SL-BSR and
SL-BSR included for padding)
MAC-CEs for IAB-MT recommended beam indication or desired IAB-MT
power spectral density (PSD) range, or MAC-CEs for desired downlink
transmission power adjustment
Data from any logical channel except data from UL-CCCH
MAC-CEs for recommended bit rate query
MAC-CEs for BSR included for padding
MAC-CEs for SL-BSR included for padding

In some aspects, a UE may determine how to prioritize among MAC-CEs of the same priority. In some aspects, a MAC entity may prioritize (e.g., over sidelink transmission) any MAC-CE (e.g., at the MAC-CE level) that is listed in a higher priority order than MAC-CEs for data from any logical channel, except data from an UL-CCCH.

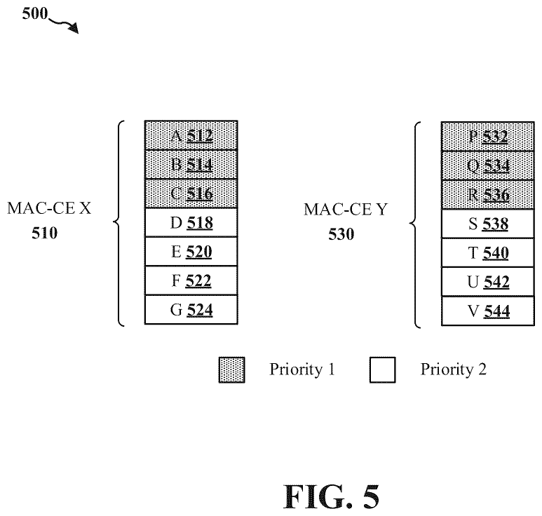

FIG. 5 is a diagram 500 illustrating examples of the contents included in example MAC-CEs. As shown in FIG. 5, in an example where MAC-CE X 510 carries the information set of {A 512, B 514, C 516, D 518, E 520, F 522, G 524} and MAC-CE Y 530 carries the information set {P 532, Q 534, R 536, S 538, T 540, U 542, V 544}. If the UE determines to perform truncation (e.g., due to insufficient granted resources to transmit all of the information in MAC-CE X 510 and MAC-CE Y 530), both MAC-CE X 510 and MAC-CE Y 530 may be truncated at the last part of the MAC-CE (e.g., in MAC-CEs for BSR or LTM). In some examples, even if MAC-CE X 510 is assigned a higher priority than MAC-CE Y 530, some information within MAC-CE X 510, for example, {E 520, F 522, G 524}, may have lower importance than some information within MAC-CE Y 530, for example, {P 532, Q 534, R 536}. However, the prioritization and truncation mechanisms based solely on the absolute priority of each MAC-CE, e.g., such as based on the order in Table 2, do not consider the logical relationship (e.g., the relative importance) of the various contents across different MAC-CEs.

In some examples, each MAC-CE (e.g., MAC-CE X 510, MAC-CE Y 530) may contain multiple levels of priority information, e.g., different content associated with different priority levels. For example, both MAC-CE X 510 and MAC-CE Y 530 may include two levels of priority content, which may be designated as priority 1 and priority 2, for example. The priority 1 content may provide information that is important for decision-making for the network, while the priority 2 content may provide information of less importance to the network. As an example, in MAC-CE X 510, contents A 512, B 514, C 516 may be associated with a first priority level (e.g., priority 1), and contents D 518, E 520, F 522, and G 524 may be associated with a second priority level (e.g., priority 2). In MAC-CE Y 530, contents P 532, Q 534, R 536 may be associated with a first priority level (e.g., priority 1), and contents S 538, T 540, U 542, V 544 may be associated with a second priority level (priority 2). Based on the prioritization and truncation mechanisms at the MAC-CE level, e.g., that rely on the absolute priority of each MAC-CE type, MAC-CE X 510 has a higher absolute priority than MAC-CE Y 530 and will be transmitted first using the available grant. As a result, MAC-CE Y 530 may be delayed until the next available transmission opportunity. However, postponing the transmission of MAC-CE Y 530 may result in missing important information needed for decision-making or functional processing at the receiver (e.g., priority 1 contents P 532, Q 534, R 536 in MAC-CE Y 530). Additionally, if another MAC-CE Z having a higher priority than MAC-CE Y 530 is triggered in the next opportunity for MAC-CE transmission, the UE may further delay the transmission of MAC-CE Y 530, e.g., based on limited resources from scheduling grants. In some examples, some MAC-CEs may be larger in size and may consume the entire available grant (e.g., use all of the allocated resources), such as when a small grant is allocated due to, for example, scheduling constraints, poor radio conditions at the cell edge, or pre-configured configured grant (CG) values. The transmission of such large MAC-CEs may further delay the transmission of MAC-CE Y 530. Hence, important information in MAC-CE Y 530, such as contents P 532, Q 534, R 536, may be delayed or omitted, adversely impacting wireless communication.

In some examples, MAC-CE truncation may be performed based on various factors, including event-based criteria. For example, in LTM, when multiple events, such as reference signal received power (RSRP) of the serving beam or candidate beam trigger the LTM, the corresponding MAC-CE may be truncated depending on the available grants for MAC-CE transmission. However, these truncation mechanisms are used to fit the remaining bits of a single MAC-CE within the available grant after truncation. Such truncation mechanisms do not prioritize and transmit selected parts from multiple MAC-CEs based on content-level priority, e.g., prioritization based on different content within multiple MAC-CEs. Instead, they focus solely on maximizing the content of a single MAC-CE. Hence, these truncation mechanisms may not prevent the delay or omissions of the transmission of important information (e.g., content P 532, Q 534, R 536) in a lower-priority MAC-CE (e.g., MAC-CE Y 530). Example aspects presented herein relate to improved MAC-CE design. Some example aspects provide methods and apparatus that enable additional priority levels for each element within a MAC-CE, so that when truncation is needed, the elements within a MAC-CE can be compared across different MAC-CEs. Some example aspects provide methods and apparatus that allow the determination of MAC-CE priorities based on their contents, including mechanisms for configuring the relationship between different MAC-CEs. With the increasing amount of MAC-CE content, multiple MAC-CEs are being triggered with increasing MAC-CE functionality across various domains. As multiple procedures are moved to MAC from RRC, PDCP, and RLC, and as reaction time becomes stricter from the slot-level boundaries, the aspects presented herein help to ensure timely delivery of important MAC-CE content from various MAC-CEs even with limited transmission resources assigned.

In some aspects, the prioritization among MAC-CEs may be enhanced by incorporating content-based prioritization in addition to the absolute priority order of MAC-CEs. This approach allows for a more efficient allocation of limited transmission resources by ensuring that higher-priority content is transmitted first, even when the transmission grants are limited and truncation is necessary.

In some aspects, the content-based prioritization of MAC-CEs may be implemented in two steps. In the first step, the contents of each MAC-CE are divided into multiple priority levels. The priority levels for the contents of each MAC-CE may be determined based on the importance of these contents in wireless communication. For example, different content within a MAC-CE may be associated with different priority levels (e.g., which may be referred to as “content priority levels” to differentiate from a MAC-CE level priority of the whole MAC-CE). The factors to be considered when determining the importance of these contents may include, for example, the time sensitivity or urgency of the contents, the impact of the contents on tasks such as resource scheduling or beam management, or the need for the content to maintain the connectivity. For example, in a BSR MAC-CE, logical channel groups (LCG) 0-3 may be assigned priority 1 (e.g., a higher priority), and LCG 4-7 may be assigned priority 2 (e.g., a lower priority). For example, in a PHR MAC-CE, information related to specific cells may be assigned as priority 1 (e.g., a higher priority), while information related to other cells may be assigned priority 2 (e.g., a lower priority). For example, in LTM MAC-CE, serving beam information may be assigned as priority 1 (e.g., a higher priority), and candidate beam information may be assigned priority 2 (e.g., a lower priority).

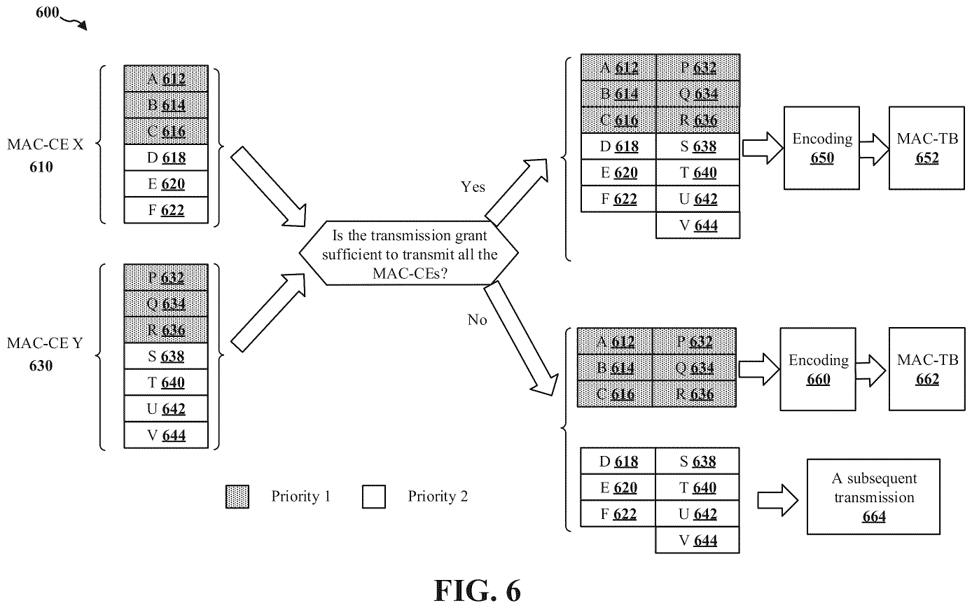

In the second step, while the relative priority of each MAC-CE remains unchanged, content-based prioritization allows higher-priority elements across multiple MAC-CEs to be transmitted first. FIG. 6 is a diagram 600 illustrating a MAC-CE prioritization method in accordance with various aspects of the present disclosure. In the example in FIG. 6, the multiple MAC-CEs include MAC-CE X 610 and MAC-CE Y 630, each of which contains two levels of priority content (e.g., priority 1 and priority 2). For example, MAC-CE X 610 may include priority 1 (e.g., high priority) content of A 612, B 614, C 616, and priority 2 (e.g., low priority) content of D 618, E 620, F 622. MAC-CE Y 630 may include priority 1 (e.g., high priority) content of P 632, Q 634, R 636 and priority 2 (e.g., low priority) content of S 638, T 640, U 642, and V 644.

The encoding process of the multiple MAC-CEs to build a MAC-TB may be improved based on the priorities of the contents in the multiple MAC-CEs (e.g., MAC-CE X 610, MAC-CE Y 630). In some examples, if the transmission grant is sufficient to accommodate the transmission the multiple MAC-CEs (e.g., MAC-CE X and MAC-CE Y), then the encoding process (e.g., at 650) may include encoding all contents from the multiple MAC-CEs (e.g., MAC-CE X 610 and MAC-CE Y 630) into a MAC-TB (e.g., MAC-TB 652). However, if the transmission grant is not sufficient to transmit all the contents in the multiple MAC-CEs (e.g., MAC-CE X 610 and MAC-CE Y 630), the encoding process (e.g., at 660) may be adjusted to prioritize higher-priority content across the MAC-CEs. In some examples, transmission grants (e.g., the time and frequency resources allocated for MAC-CE transmission by the UE) may be limited due to factors such as network congestion, even in favorable radio conditions, or because of bandwidth constraints within a given vertical. In some examples, transmission grants may be limited due to poor radio conditions, such as those experienced at the cell edge.

As shown in FIG. 6, when the transmission grant is limited and is not sufficient to transmit all the contents in the multiple MAC-CEs, priority 1 contents across the multiple MAC-CEs, such as contents A 612, B 614, C 616 in MAC-CE X 610 and contents P 632, Q 634, R 636 in MAC-CE Y 630, may be encoded (e.g., at 660) into a MAC-TB (e.g., MAC-TB 662), while lower-priority elements across the multiple MAC-CEs, such as contents D 618, E 620, F 622 in MAC-CE X 610 and contents S 638, T 640, U 642, V 644 in MAC-CE Y 630, may be deferred to a later opportunity, for example, to a subsequent transmission 664. This approach ensures that important information across multiple MAC-CEs is prioritized and delivered in a timely manner, even with limited transmission resources.

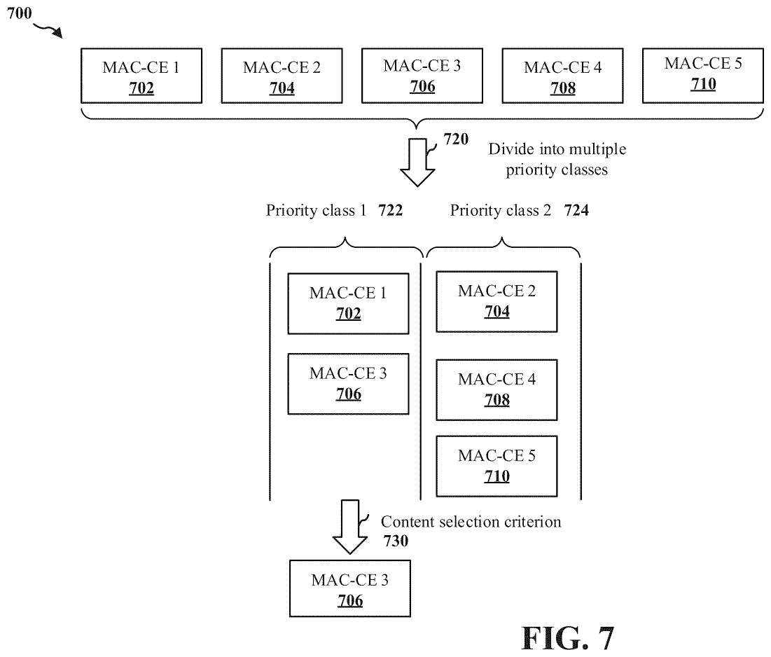

In some aspects, instead of relying solely on an absolute priority order for all MAC-CEs, in the content-based prioritization, multiple MAC-CEs may be divided into multiple priority classes. Within each priority class, the selection of which MAC-CE to transmit first may be determined based on the contents of the MAC-CE. FIG. 7 is a diagram 700 illustrating a content-based MAC-CE prioritization method in accordance with various aspects of the present disclosure. In the example of FIG. 7, multiple MAC-CEs may include MAC-CE 1 702, MAC-CE 2 704, MAC-CE 3 706, MAC-CE 4 708, MAC-CE 5 710. These MAC-CEs may first be divided into multiple priority classes at 720. For example, MAC-CE 1 702 and MAC-CE 3 706 may be grouped into priority class 1 722 (e.g., high priority class), and MAC-CE 2 704 and MAC-CE 4 708, and MAC-CE 5 710 may be grouped into priority class 2 724 (e.g., low priority class). In some examples, the grouping or dividing of the MAC-CEs into the priority classes may be based on the absolute priority of the MAC-CEs relative to other MAC-CEs. For example, in the example of FIG. 7, MAC-CE 1 702 and MAC-CE 3 706 may have a higher absolute priority than MAC-CE 2 704, MAC-CE 4 708, and MAC-CE 5 710. Therefore, MAC-CE 1 702 and MAC-CE 3 706 are grouped into priority class 1 722, while MAC-CE 2 704, MAC-CE 4 708, and MAC-CE 5 710 are grouped into priority class 2 724.

Within each priority class, the selection of which MAC-CE to transmit first may be determined based on the contents of the MAC-CE. For example, within each priority class, one or more MAC-CEs may be selected to be transmitted first from the multiple MAC-CEs within the priority class based on a content selection criterion (e.g., at 730). In some examples, the content selection criterion may be based on a defined rule (e.g., a rule in wireless communication standards). In some examples, the content selection criterion may be configured to the UE via a common signaling or a dedicated signaling. For example, in FIG. 7, when the transmission resource is not sufficient to transmit all the MAC-CEs (MAC-CE 1 702, MAC-CE 2 704, MAC-CE 3 706, MAC-CE 4 708, and MAC-CE 5 710), one or more MAC-CEs (e.g., MAC-CE 1 701, MAC-CE 3 706) in the higher priority classes (e.g., priority class 1 722) may be selected to be transmitted first based on the contents of these MAC-CEs. For example, the selection of the one or more MAC-CEs may be based on a content selection criterion (e.g., at 730).

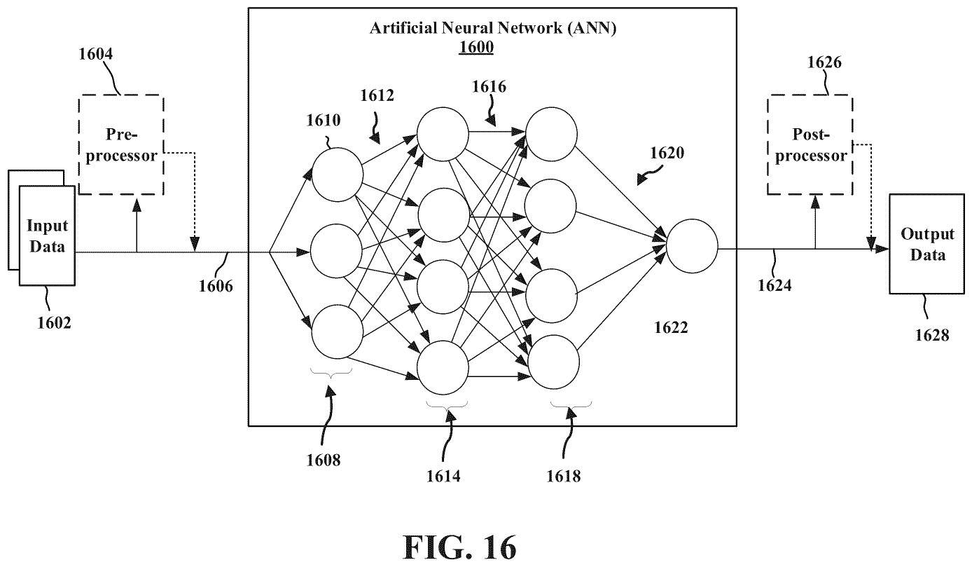

In some examples, the content selection criterion may be determined by the UE based on the UE's internal knowledge or information. This knowledge or information may include, for example, UE specific information, the application in use, network conditions, and current radio environment. In some examples, the UE's internal knowledge or information may include output from a model, such as an artificial intelligence/machine learning (AI/ML) model. In some examples, the AI/ML model may be an internal model of the UE. In some examples, the AI/ML model may be a model coordinated between the UE and the network. In some examples, the AI/ML model may be an application-based model. In some examples, the AI/ML model may be a combination of these models (e.g., an internal model, a coordinated model, or an application-based model). Example aspects of an AI/ML model that may be used to identify content selection criterion for prioritization of content among different MAC-CEs is described in connection with FIG. 16.

With this enhancement to the prioritization of MAC-CEs, even when multiple MAC-CEs are triggered at the same time, higher priority contents across multiple MAC-CEs may be transmitted at the earliest transmission opportunities. This allows for improved user experience and enhanced performance for wireless communication. The enhancement to the prioritization of MAC-CEs may be applicable to various MAC-CEs used in wireless communication. As a non-exhaustive list, the MAC-CEs may include MAC-CEs for cell radio network temporary identifier (C-RNTI), MAC-CEs for data from the uplink common control channel (UL-CCCH), MAC-CEs for beam failure recovery (BFR) or enhanced BFR, MAC-CEs for configured grant confirmation, or multiple entry configured grant confirmation, MAC-CEs for sidelink configured grant confirmation, MAC-CEs for listen-before-talk (LBT) failure, MAC-CEs for timing advance report, MAC-CEs for sidelink buffer status report (SL-BSR), MAC-CEs for BSR or extended BSR (except the BSR included for padding), MAC-CEs for (enhanced) single entry PHR or (enhanced) multiple entry PHR, MAC-CEs for positioning measurement gap activation/deactivation request, MAC-CEs for the number of desired guard symbols, MAC-CEs for Case-6 timing request, or MAC-CE for (extended) pre-emptive BSR. In some examples, the MAC-CEs may also include MAC-CEs for SL-BSR, MAC-CEs for integrated access and backhaul mobile termination (IAB-MT) recommended beam indication, MAC-CEs for desired IAB-MT power spectral density (PSD) range, MAC-CEs for desired downlink transmission power adjustment, MAC-CEs for recommended bit rate query, or MAC-CEs for BSR included for padding. The MAC-CEs listed above do not form an exhaustive list, and the enhancement to the prioritization of MAC-CEs may be applicable to other MAC-CEs not listed here or developed in the future.

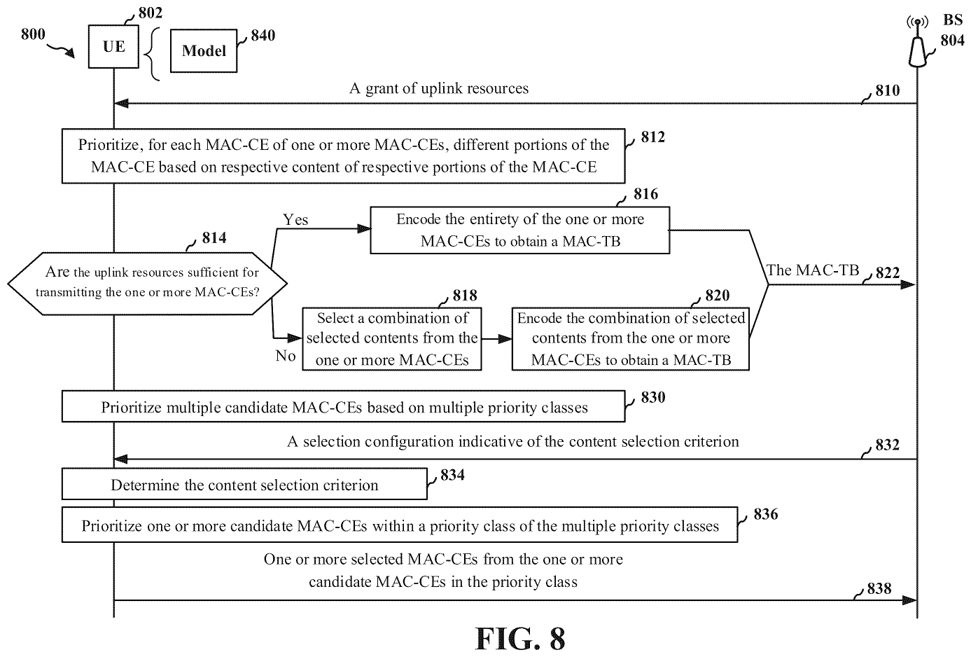

FIG. 8 is a call flow diagram 800 illustrating a method of wireless communication in accordance with various aspects of this present disclosure. Various aspects are described in connection with a UE 802 and a base station 804. The aspects may be performed by the UE 802 or the base station 804 in aggregation and/or by one or more components of a base station 804 (e.g., a CU 110, a DU 130, and/or an RU 140). In some aspects, the UE 802 may include or be associated with a model 840. As an example, the model 840 may be an artificial intelligence/machine learning (AI/ML) model. In some examples, the AI/ML model may be an internal model of the UE 802. In some examples, the AI/ML model may be a coordinated model between the UE 802 and base station 804. In some examples, the AI/ML model may be an application-based model. The AI/ML model may include any of the aspects described in connection with FIG. 16, for example.

As shown in FIG. 8, at 810, the UE 802 may receive a grant of uplink resources. The uplink resources may be used to transmit one or more MAC-CEs.

At 812, the UE 802 may prioritize, for each MAC-CE of one or more MAC-CEs, different portions of the MAC-CE based on the respective content of respective portions of the MAC-CE. Different content within the MAC-CE is associated with a separate priority level of multiple priority levels. For example, referring to FIG. 6, the one or more MAC-CEs may include MAC-CE X 610 and MAC-CE Y 630. The UE may prioritize contents A 612, B 614, C 616 in MAC-CE X 610 as priority 1, and prioritize contents D 618, E 620, F 622 in MAC-CE X 610 as priority 2. The UE may further prioritize contents P 632, Q 634, R 636 in MAC-CE Y 630 as priority 1, and prioritize contents S 638, T 640, U 642, V 644 in MAC-CE Y 630 as priority 2.

At 814, the UE 802 may determine whether the uplink resources are sufficient for transmitting all of the one or more MAC-CEs. If the uplink resources are sufficient for transmitting all of the one or more MAC-CEs, the UE 802 may, at 816, encode the entirety of the one or more MAC-CEs to obtain a MAC-TB, and, at 822, transmit the MAC-TB to the base station 804. On the other hand, if the uplink resources are insufficient for transmitting all of the one or more MAC-CEs, the UE may, at 818, select a combination of selected contents from the one or more MAC-CEs based on the multiple priority levels.

Referring to FIG. 6, as an example, the one or more MAC-CEs may include a first MAC-CE (e.g., MAC-CE X 610) and a second MAC-CE (e.g., MAC-CE Y 630). The first MAC-CE may include a first selected content (e.g., contents A 612, B 614, C 616) that has a first priority (e.g., priority 1), and the second MAC-CE (e.g., MAC-CE Y 630) may include a second selected content (e.g., contents P 632, Q 634, R 636) that has the first priority (e.g., priority 1). Then, the combination of selected contents may include a combination of the first selected content (e.g., contents A 612, B 614, C 616) and the second selected content (e.g., contents P 632, Q 634, R 636) due to their higher priority. On the other hand, the first MAC-CE (e.g., MAC-CE X 610) may further include other contents (e.g., a first unselected content), such as contents D 618, E 620, F 622, that have lower priority (e.g., a second priority lower than the first priority) than the first selected content (e.g., contents A 612, B 614, C 616), and the second MAC-CE (e.g., MAC-CE Y 630) may also include other contents (e.g., a second unselected content), such as contents S 638, T 640, U 642, V 644, that have lower priority (e.g., the second priority) than the second selected content (e.g., contents P 632, Q 634, R 636). Those contents with lower priority (e.g., the first unselected content and the second unselected content) may not be selected to be transmitted to the base station 804 due to limited uplink resources. Instead, those contents with lower priority (e.g., contents D 618, E 620, F 622, S 638, T 640, U 642, V 644) may be transmitted at a subsequent transmission opportunity (e.g., at 664).

At 820, the UE 802 may encode the combination of selected contents from the one or more MAC-CEs to obtain a MAC-TB, and, at 822, transmit the MAC-TB to the base station 804. For example, referring to FIG. 6, the UE may, at 660, encode the combination of contents A 612, B 614, C 616 from MAC-CE X 610 and contents P 632, Q 634, R 636 from MAC-CE Y 630 to obtain a MAC-TB 662, and transmit the MAC-TB 662 to the base station.

In some aspects, to transmit the one or more MAC-CE based on the uplink resources, the UE 802 may, at 830, first prioritize multiple MAC-CEs (e.g., candidate MAC-CEs) based on multiple priority classes. For example, referring to FIG. 7, the multiple MAC-CEs may include MAC-CE 1 702, MAC-CE 2 704, MAC-CE 3 706, MAC-CE 4 708, MAC-CE 5 710. The UE may prioritize MAC-CE 1 702 and MAC-CE 3 706 as priority class 1 722, and prioritize MAC-CE 2 704, MAC-CE 4 708, and MAC-CE 5 710 as priority class 2 724.

At 832, the UE 802 may receive from base station 804 a selection configuration indicative of the content selection criterion. The UE 802 may select one or more candidate MAC-CEs from the multiple candidate MAC-CEs to transmit to base station 804 based on the content selection criterion when the uplink resources are not sufficient to transmit all of the candidate MAC-CEs. For example, referring to FIG. 7, the UE may select MAC-CE 3 706 from the multiple candidate MAC-CEs (e.g., MAC-CE 1 702 and MAC-CE 3 706 in priority class 1 722) to transmit to the base station based on the content selection criterion (e.g., at 730) when the uplink resources are not sufficient to transmit all of the candidate MAC-CEs.

In some examples, instead of receiving the content selection criterion from base station 804, the UE 802 may, at 834, determine the content selection criterion based on information of the UE. For example, the information of the UE may include information related to an application associated with the UE, information related to a network associated with the UE, or information about the radio condition. In some examples, the information of the UE may be based on is an output of a model (e.g., model 840), such as an AI/ML model associated with the UE 802. For example, the AI/ML model may include one or more of: an internal model of the UE 802, a coordinated model between the UE 802 and the base station 804, or an application-based model.

At 836, the UE 802 may prioritize one or more candidate MAC-CEs within a priority class of the multiple priority classes. For example, to prioritize one or more candidate MAC-CEs, the UE 802 may select the one or more selected MAC-CEs from the first set of MAC-CEs based on a content selection criterion (e.g., obtained at 832 or 834). For example, referring to FIG. 7, the UE may select MAC-CE 3 706 from MAC-CE 1 702 and MAC-CE 3 706 in priority class 1 722 based on the content selection criterion (e.g., at 730).

At 838, the UE 802 may transmit to base station 804 the one or more selected MAC-CEs from the one or more candidate MAC-CEs in the priority class.

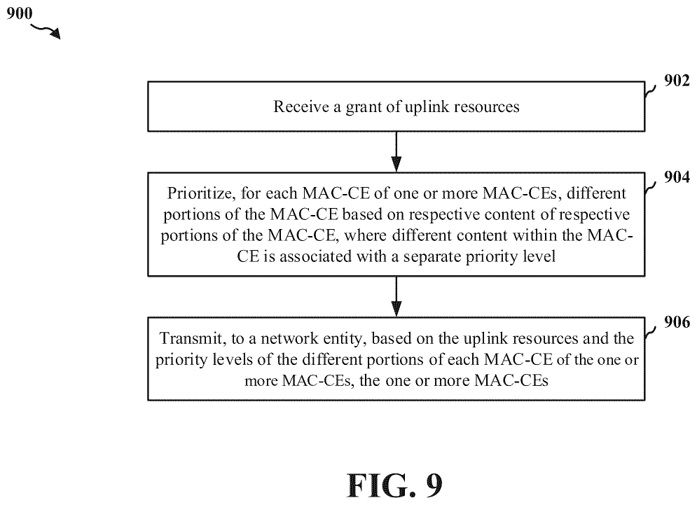

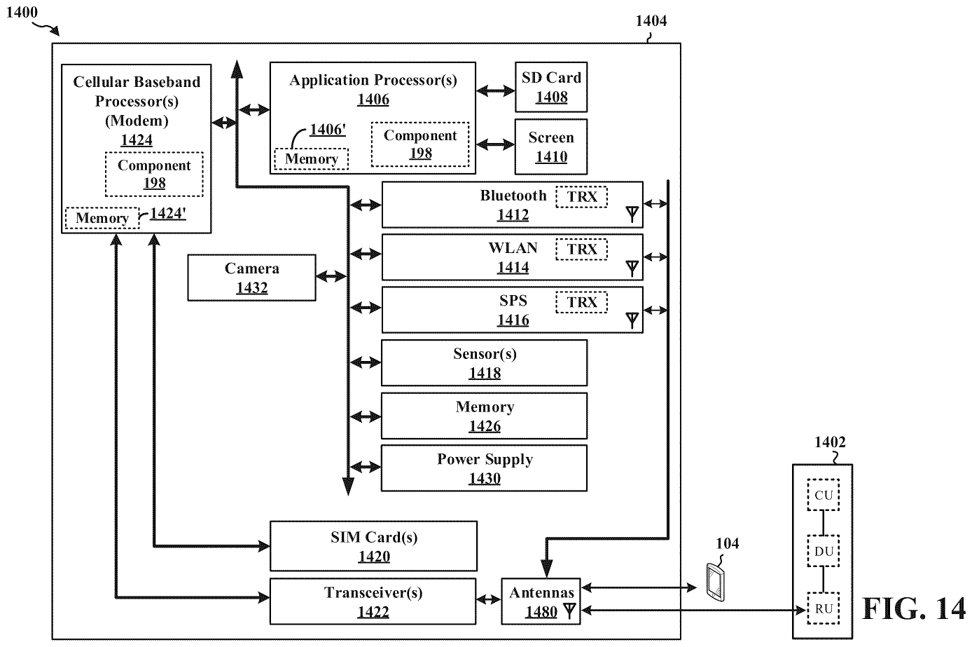

FIG. 9 is a flowchart 900 illustrating methods of wireless communication at a UE in accordance with various aspects of the present disclosure. The method may be performed by a UE in collaboration with a network entity. The network entity may be a base station, or a component of a base station, in the access network of FIG. 1 or a core network component (e.g., base station 102, 310, 804; or the network entity 1402 in the hardware implementation of FIG. 14). The UE may be the UE 104, 350, 802, or the apparatus 1404 in the hardware implementation of FIG. 14. By enabling content-based prioritization across different MAC-CEs, the methods ensure that high-priority contents from lower-priority MAC-CEs are not unnecessarily delayed and reduce the risk of missing important information in the MAC-CEs when transmission resources are limited. Additionally, by allowing MAC-CE prioritization to be configured through standards, signaling, or UE implementation, the methods provide flexibility in adapting prioritization strategies based on real-time network conditions and use cases. In some examples, by introducing multiple priority classes instead of relying solely on absolute priority order among the MAC-CEs, the methods improve scheduling efficiency, and the efficiency and timeliness of MAC-CE transmissions.

As shown in FIG. 9, at 902, the UE may receive a grant of uplink resources. FIG. 6, FIG. 7, and FIG. 8 illustrate various aspects of the steps in connection with flowchart 900. For example, referring to FIG. 8, the UE 802 may, at 810, receive a grant of uplink resources. In some aspects, 902 may be performed by the prioritization component 198.

At 904, the UE may prioritize different portions of the MAC-CE based on the respective content of respective portions of the MAC-CE for each MAC-CE of one or more MAC-CEs. Different content within the MAC-CE may be associated with a separate priority level. For example, referring to FIG. 8, the UE 802 may, at 812, prioritize different portions of the MAC-CE based on the respective content of respective portions of the MAC-CE for each MAC-CE of one or more MAC-CEs. Referring to FIG. 6, the one or more MAC-CEs may include MAC-CE X 610 and MAC-CE Y 630. The UE may prioritize contents A 612, B 614, C 616 in MAC-CE X 610 as priority 1, and prioritize contents D 618, E 620, F 622 in MAC-CE X 610 as priority 2. The UE may further prioritize contents P 632, Q 634, R 636 in MAC-CE Y 630 as priority 1, and prioritize contents S 638, T 640, U 642, V 644 in MAC-CE Y 630 as priority 2. In some aspects, 904 may be performed by the prioritization component 198.

At 906, the UE may transmit the one or more MAC-CEs to a network entity based on the uplink resources and the priority levels of the different portions of each MAC-CE the one or more MAC-CEs. For example, referring to FIG. 8, the UE 802 may, at 838, transmit the one or more MAC-CEs to a network entity (e.g., base station 804) based on the uplink resources and the priority levels of the different portions of each MAC-CE the one or more MAC-CEs. In some aspects, 906 may be performed by the prioritization component 198.

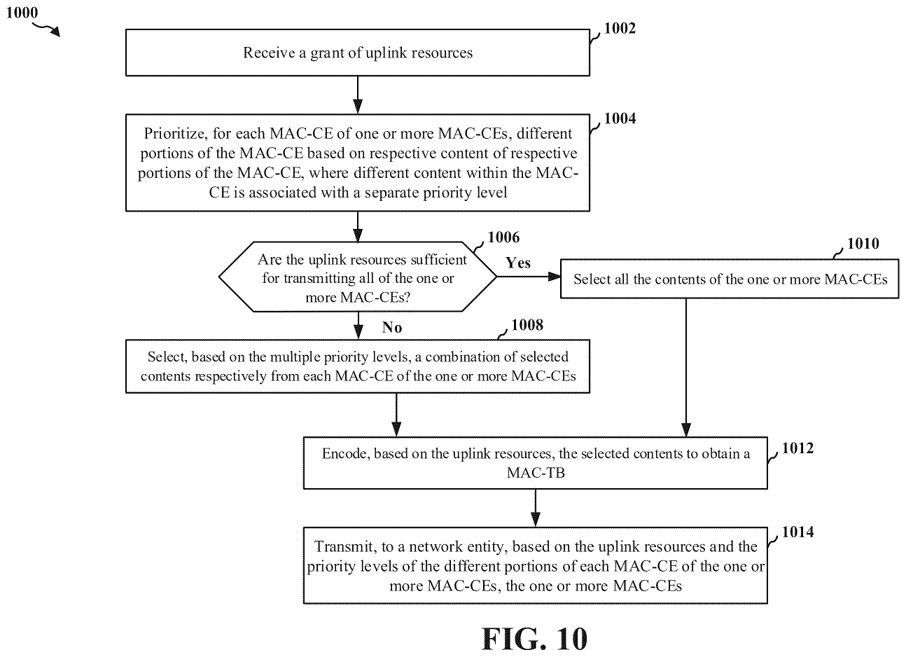

FIG. 10 is a flowchart 1000 illustrating methods of wireless communication at a UE in accordance with various aspects of the present disclosure. The method may be performed by a UE in collaboration with a network entity. The network entity may be a base station, or a component of a base station, in the access network of FIG. 1 or a core network component (e.g., base station 102, 310, 804; or the network entity 1402 in the hardware implementation of FIG. 14). The UE may be the UE 104, 350, 802, or the apparatus 1404 in the hardware implementation of FIG. 14. By enabling content-based prioritization across different MAC-CEs, the methods ensure that high-priority contents from lower-priority MAC-CEs are not unnecessarily delayed and reduce the risk of missing important information in the MAC-CEs when transmission resources are limited. Additionally, by allowing MAC-CE prioritization to be configured through standards, signaling, or UE implementation, the methods provide flexibility in adapting prioritization strategies based on real-time network conditions and use cases. In some examples, by introducing multiple priority classes instead of relying solely on absolute priority order among the MAC-CEs, the methods improve scheduling efficiency, and the efficiency and timeliness of MAC-CE transmissions.

As shown in FIG. 10, at 1002, the UE may receive a grant of uplink resources. FIG. 6, FIG. 7, and FIG. 8 illustrate various aspects of the steps in connection with flowchart 900. For example, referring to FIG. 8, the UE 802 may, at 810, receive a grant of uplink resources. In some aspects, 1002 may be performed by the prioritization component 198.

At 1004, the UE may prioritize different portions of the MAC-CE based on the respective content of respective portions of the MAC-CE for each MAC-CE of one or more MAC-CEs. Different content within the MAC-CE may be associated with a separate priority level. For example, referring to FIG. 8, the UE 802 may, at 812, prioritize different portions of the MAC-CE based on the respective content of respective portions of the MAC-CE for each MAC-CE of one or more MAC-CEs. Referring to FIG. 6, the one or more MAC-CEs may include MAC-CE X 610 and MAC-CE Y 630. The UE may prioritize contents A 612, B 614, C 616 in MAC-CE X 610 as priority 1, and prioritize contents D 618, E 620, F 622 in MAC-CE X 610 as priority 2. The UE may further prioritize contents P 632, Q 634, R 636 in MAC-CE Y 630 as priority 1, and prioritize contents S 638, T 640, U 642, V 644 in MAC-CE Y 630 as priority 2. In some aspects, 1004 may be performed by the prioritization component 198.

At 1014, the UE may transmit the one or more MAC-CEs to a network entity based on the uplink resources and the priority levels of the different portions of each MAC-CE the one or more MAC-CEs. For example, referring to FIG. 8, the UE 802 may, at 838, transmit the one or more MAC-CEs to a network entity (e.g., base station 804) based on the uplink resources and the priority levels of the different portions of each MAC-CE the one or more MAC-CEs. In some aspects, 1014 may be performed by the prioritization component 198.

In some aspects, the priority levels for the respective content of the MAC-CE may be based on one or more of: logic channel group (LCG) information of the respective content of the MAC-CE, service beam information of the respective content of the MAC-CE, or cell information of the respective content of the MAC-CE. For example, referring to FIG. 6, the priority levels (e.g., priority 1 for content A 612 or priority 2 for content D 618) for the respective content of the MAC-CE (e.g., MAC-CE X 610) may be based on one or more of: logic channel group (LCG) information of the respective content of the MAC-CE (e.g., MAC-CE X 610), service beam information of the respective content of the MAC-CE (e.g., MAC-CE X 610), or cell information of the respective content of the MAC-CE (e.g., MAC-CE X 610).

In some aspects, to transmit the one or more MAC-CEs (e.g., at 1014), the UE may transmit a combination of a first selected content from a first MAC-CE in the one or more MAC-CEs and a second selected content from a second MAC-CE in the one or more MAC-CEs. The first selected content may be selected from first MAC contents of the first MAC-CE, the second selected content may be selected from second MAC contents of the second MAC-CE. The first MAC contents and the second MAC contents may be respectively associated with at least one priority level of multiple priority levels, and the combination of the first selected content and the second selected content is based on the multiple priority levels. For example, referring to FIG. 6, the UE may transmit a combination of a first selected content (e.g., contents A 612, B 614, C 616) from a first MAC-CE (e.g., MAC-CE X 610) and a second selected content (e.g., contents P 632, Q 634, R 636) from a second MAC-CE (e.g., MAC-CE Y 630). The first selected content (e.g., contents A 612, B 614, C 616) may be selected from first MAC contents (e.g., contents A 612, B 614, C 616, D 618, E 620, F 622) of the first MAC-CE (e.g., MAC-CE X 610), the second selected content (e.g., contents P 632, Q 634, R 636) may be selected from second MAC contents (e.g., contents P 632, Q 634, R 636, S 638, T 640, U 642, V 644) of the second MAC-CE (e.g., MAC-CE Y 630). The first MAC contents and the second MAC contents may be respectively associated with at least one priority level of multiple priority levels (e.g., priority 1 and priority 2), and the combination of the first selected content (e.g., contents A 612, B 614, C 616) and the second selected content (e.g., contents P 632, Q 634, R 636) is based on the multiple priority levels.

In some aspects, at 1012, the UE may encode, based on the uplink resources, the combination of the first selected content and the second selected content to obtain a MAC-TB. To transmit the combination of the first selected content and the second selected content (e.g., at 1014), the UE may transmit the MAC-TB. For example, referring to FIG. 8, the UE 802 may, at 820, encode, based on the uplink resources, the combination of the first selected content and the second selected content to obtain a MAC-TB. Referring to FIG. 6, the UE may encode, at 660, based on the uplink resources, the combination of the first selected content (e.g., contents A 612, B 614, C 616) and the second selected content (e.g., contents P 632, Q 634, R 636) to obtain a MAC-TB 662. In some aspects, 1012 may be performed by the prioritization component 198.

In some aspects, at 1006, the UE may determine whether the uplink resources are sufficient for transmitting all of the one or more MAC-CEs. In some examples, the uplink resources may be sufficient to transmit all of the one or more MAC-CEs. In an example where the one or more MAC-CEs include the first MAC-CE and the second MAC-CE, the uplink resources may have a resource size exceeding a transmission size for transmitting the first MAC-CE and the second MAC-CE. In that case, the UE may, at 1010, select the entirety of the first MAC-CE and the second MAC-CE to transmit to the network entity. That is, the first selected content may include the entirety of the first MAC contents, and the second selected content may include the entirety of the second MAC contents. For example, referring to FIG. 8, UE 802 may, at 814, determine whether the uplink resources are sufficient for transmitting all of the one or more MAC-CEs. If the uplink resources are sufficient to transmit all of the one or more MAC-CEs, the UE 802 may, at 816, select the entirety of the one or more MAC-CEs (e.g., encode the entirety of the one or more MAC-CEs) and transmit them to the network entity (e.g., base station 804). In some aspects, 1006 and 1010 may be performed by the prioritization component 198.

In some examples, the uplink resources may be insufficient to transmit all of the one or more MAC-CEs. In an example where the one or more MAC-CEs include the first MAC-CE and the second MAC-CE, the uplink resources may have a resource size that is less than the transmission size for transmitting the first MAC-CE and the second MAC-CE. In that case, the UE may, at 1008, select, based on the multiple priority levels, the first selected content and the second selected content respectively from the first MAC contents and the second MAC contents. For example, referring to FIG. 8, if the uplink resources are insufficient to transmit all of the one or more MAC-CEs, the UE 802 may, at 818, select a combination of selected contents from the one or more MAC-CEs. Referring to FIG. 6, the UE may select the first selected content (e.g., contents A 612, B 614, C 616) and the second selected content (e.g., contents P 632, Q 634, R 636) respectively from the first MAC contents (e.g., contents A 612, B 614, C 616, D 618, E 620, F 622) and the second MAC contents (e.g., contents P 632, Q 634, R 636, S 638, T 640, U 642, V 644). In some aspects, 1008 may be performed by the prioritization component 198.

In some aspects, to select the first selected content and the second selected content respectively from the first MAC contents and the second MAC contents (e.g., at 1008), the UE may select, based on the resource size and a descending order of priority levels of the first MAC contents and the second MAC contents, the first selected content and the second selected content respectively from the first MAC contents and the second MAC contents. The contents with a higher priority level may be selected before the contents of a lower priority level. For example, referring to FIG. 6, the UE may select the first selected content (e.g., contents A 612, B 614, C 616) and the second selected content (e.g., contents P 632, Q 634, R 636) respectively from the first MAC contents (e.g., contents A 612, B 614, C 616, D 618, E 620, F 622) and the second MAC contents (e.g., contents P 632, Q 634, R 636, S 638, T 640, U 642, V 644). The first selected content (e.g., contents A 612, B 614, C 616) and the second selected content (e.g., contents P 632, Q 634, R 636) have a higher priority level (e.g., priority 1) than the remaining contents in the first MAC contents and the second MAC contents.

In some aspects, the first MAC contents may include the first selected content and a first unselected content, the second MAC contents include the second selected content and a second unselected content, and the first selected content and the second selected content are associated with a first priority level of the multiple priority levels. The first unselected content and the second unselected content may be associated with a second priority level of the multiple priority levels, and the second priority level is lower than the first priority level. For example, referring to FIG. 6, the first unselected content (e.g., contents D 618, E 620, F 622) and the second unselected content (e.g., contents S 638, T 640, U 642, V 644) may be associated with a second priority level (e.g., priority 2) of the multiple priority levels, and the second priority level (e.g., priority 2) is lower than the first priority level (e.g., priority 1).

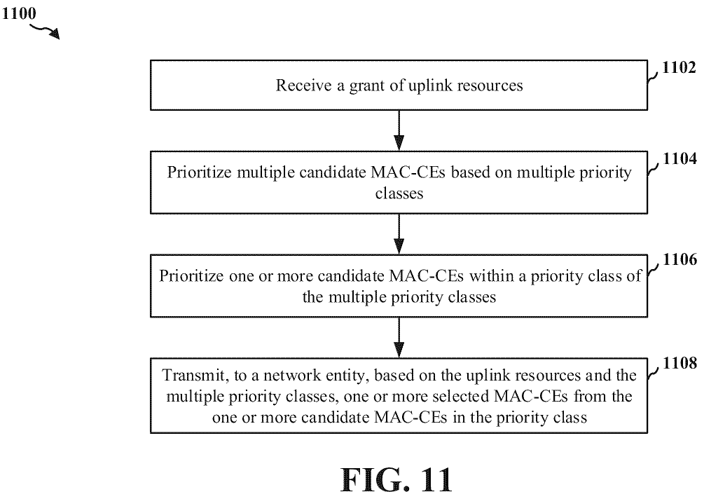

FIG. 11 is a flowchart 1100 illustrating methods of wireless communication at a UE in accordance with various aspects of the present disclosure. The method may be performed by a UE in collaboration with a network entity. The network entity may be a base station, or a component of a base station, in the access network of FIG. 1 or a core network component (e.g., base station 102, 310, 804; or the network entity 1402 in the hardware implementation of FIG. 14). The UE may be the UE 104, 350, 802, or the apparatus 1404 in the hardware implementation of FIG. 14. By enabling content-based prioritization across different MAC-CEs, the methods ensure that high-priority contents from lower-priority MAC-CEs are not unnecessarily delayed and reduce the risk of missing important information in the MAC-CEs when transmission resources are limited. Additionally, by allowing MAC-CE prioritization to be configured through standards, signaling, or UE implementation, the methods provide flexibility in adapting prioritization strategies based on real-time network conditions and use cases. In some examples, by introducing multiple priority classes instead of relying solely on absolute priority order among the MAC-CEs, the methods improve scheduling efficiency, and the efficiency and timeliness of MAC-CE transmissions.

As shown in FIG. 11, at 1102, the UE may receive a grant of uplink resources. FIG. 6, FIG. 7, and FIG. 8 illustrate various aspects of the steps in connection with flowchart 1100. For example, referring to FIG. 8, the UE 802 may, at 810, receive a grant of uplink resources. In some aspects, 1102 may be performed by the prioritization component 198.

At 1104, the UE may prioritize multiple candidate MAC-CEs based on multiple priority classes. For example, referring to FIG. 8, the UE 802 may, at 830, prioritize multiple candidate MAC-CEs based on multiple priority classes. Referring to FIG. 7, the multiple MAC-CEs may include MAC-CE 1 702, MAC-CE 2 704, MAC-CE 3 706, MAC-CE 4 708, MAC-CE 5 710. The UE may prioritize MAC-CE 1 702 and MAC-CE 3 706 as priority class 1 722, and prioritize MAC-CE 2 704, MAC-CE 4 708, and MAC-CE 5 710 as priority class 2 724. In some aspects, 1104 may be performed by the prioritization component 198.

At 1106, the UE may prioritize one or more candidate MAC-CEs within a priority class of the multiple priority classes. For example, referring to FIG. 8, the UE 802 may, at 836, prioritize one or more candidate MAC-CEs within a priority class of the multiple priority classes. In some aspects, 1106 may be performed by the prioritization component 198.

At 1108, the UE may transmit to a network entity one or more selected MAC-CEs from the one or more candidate MAC-CEs in the priority class based on the uplink resources and the multiple priority classes. For example, referring to FIG. 8, the UE 802 may, at 838, transmit to a network entity (e.g., base station 804) one or more selected MAC-CEs from the one or more candidate MAC-CEs in the priority class based on the uplink resources and the multiple priority classes. In some aspects, 1108 may be performed by the prioritization component 198.

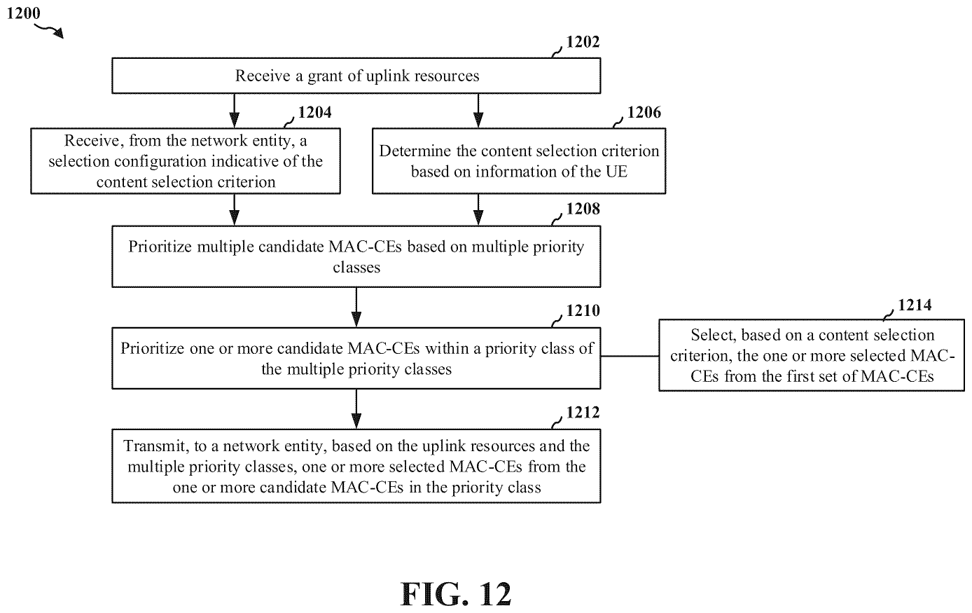

FIG. 12 is a flowchart 1200 illustrating methods of wireless communication at a UE in accordance with various aspects of the present disclosure. The method may be performed by a UE in collaboration with a network entity. The network entity may be a base station, or a component of a base station, in the access network of FIG. 1 or a core network component (e.g., base station 102, 310, 804; or the network entity 1402 in the hardware implementation of FIG. 14). The UE may be the UE 104, 350, 802, or the apparatus 1404 in the hardware implementation of FIG. 14. By enabling content-based prioritization across different MAC-CEs, the methods ensure that high-priority contents from lower-priority MAC-CEs are not unnecessarily delayed and reduce the risk of missing important information in the MAC-CEs when transmission resources are limited. Additionally, by allowing MAC-CE prioritization to be configured through standards, signaling, or UE implementation, the methods provide flexibility in adapting prioritization strategies based on real-time network conditions and use cases. In some examples, by introducing multiple priority classes instead of relying solely on absolute priority order among the MAC-CEs, the methods improve scheduling efficiency, and the efficiency and timeliness of MAC-CE transmissions.

As shown in FIG. 12, at 1202, the UE may receive a grant of uplink resources. FIG. 6, FIG. 7, and FIG. 8 illustrate various aspects of the steps in connection with flowchart 1200. For example, referring to FIG. 8, the UE 802 may, at 810, receive a grant of uplink resources. In some aspects, 1202 may be performed by the prioritization component 198.

At 1208, the UE may prioritize multiple candidate MAC-CEs based on multiple priority classes. For example, referring to FIG. 8, the UE 802 may, at 830, prioritize multiple candidate MAC-CEs based on multiple priority classes. Referring to FIG. 7, the multiple MAC-CEs may include MAC-CE 1 702, MAC-CE 2 704, MAC-CE 3 706, MAC-CE 4 708, MAC-CE 5 710. The UE may prioritize MAC-CE 1 702 and MAC-CE 3 706 as priority class 1 722, and prioritize MAC-CE 2 704, MAC-CE 4 708, and MAC-CE 5 710 as priority class 2 724. In some aspects, 1208 may be performed by the prioritization component 198.

At 1210, the UE may prioritize one or more candidate MAC-CEs within a priority class of the multiple priority classes. For example, referring to FIG. 8, the UE 802 may, at 836, prioritize one or more candidate MAC-CEs within a priority class of the multiple priority classes. In some aspects, 1210 may be performed by the prioritization component 198.

At 1212, the UE may transmit to a network entity one or more selected MAC-CEs from the one or more candidate MAC-CEs in the priority class based on the uplink resources and the multiple priority classes. For example, referring to FIG. 8, the UE 802 may, at 838, transmit to a network entity (e.g., base station 804) one or more selected MAC-CEs from the one or more candidate MAC-CEs in the priority class based on the uplink resources and the multiple priority classes. In some aspects, 1212 may be performed by the prioritization component 198.

In some aspects, each candidate MAC-CE is associated with one priority class of the multiple priority classes, and where the one or more selected MAC-CEs are selected from the one or more candidate MAC-CEs in the priority class based on MAC contents of the one or more candidate MAC-CEs. For example, referring to FIG. 7, each candidate MAC-CE (e.g., MAC-CE 1 702, MAC-CE 2 704, MAC-CE 3 706, MAC-CE 4 708, MAC-CE 5 710) is associated with one priority class (e.g., priority class 1 722 or priority class 2 724) of the multiple priority classes, and the one or more selected MAC-CEs (e.g., MAC-CE 3 706) are selected from the one or more candidate MAC-CEs in the priority class (e.g., priority class 1 722) based on MAC contents of the one or more candidate MAC-CEs (e.g., MAC-CE 3 706).

In some aspects, the MAC content of the MAC-CEs may include one or more of: identifier information for the UE, control signaling information for the UE, recovery and failure information for the UE, timing and synchronization information for the UE, positioning information for the UE, measurement information for the UE, or power control information for the UE. For example, referring to FIG. 7, the MAC content of the MAC-CEs (e.g., MAC-CE 1 702, MAC-CE 2 704, MAC-CE 3 706, MAC-CE 4 708, MAC-CE 5 710) may include one or more of: identifier information for the UE, control signaling information for the UE, recovery and failure information for the UE, timing and synchronization information for the UE, positioning information for the UE, measurement information for the UE, or power control information for the UE.

In some aspects, to prioritize the multiple candidate MAC-CEs based on the multiple priority classes (e.g., at 1208), the UE may select, based on a descending order of the priority classes of the multiple candidate MAC-CEs in the multiple priority classes, a first set of MAC-CEs from the multiple candidate MAC-CEs. To prioritize the one or more candidate MAC-CEs within the priority class of the multiple priority classes (e.g., at 1210), the UE may select, based on a content selection criterion, the one or more selected MAC-CEs from the first set of MAC-CEs (e.g., at 1214). For example, referring to FIG. 7, the UE may select a first set of MAC-CEs (e.g., MAC-CE 1 702 and MAC-CE 3 706 in priority class 1 722) from the multiple candidate MAC-CEs. To prioritize the one or more candidate MAC-CEs within the priority class of the multiple priority classes (e.g., at 1210), the UE may select, based on a content selection criterion (e.g., at 730), the one or more selected MAC-CEs (e.g., MAC-CE 3 706) from the first set of MAC-CEs (e.g., MAC-CE 1 702 and MAC-CE 3 706 in priority class 1 722). In some aspects, 1214 may be performed by the prioritization component 198.

In some aspects, the content selection criterion may be based on a defined rule. For example, referring to FIG. 7, the content selection criterion (e.g., at 730) may be based on a defined rule, such as a rule in wireless communication standards.

In some aspects, at 1204, the UE may receive, from the network entity, a selection configuration indicative of the content selection criterion. For example, referring to FIG. 8, the UE 802 may, at 832, receive, from the network entity (e.g., base station 804), a selection configuration indicative of the content selection criterion. In some aspects, 1204 may be performed by the prioritization component 198.

In some aspects, the selection configuration is received (e.g., at 1004) via a common signaling. For example, referring to FIG. 8, the selection configuration may be received (e.g., at 832) via a common signaling.

In some aspects, the selection configuration is received (e.g., at 1004) via a dedicated signaling. For example, referring to FIG. 8, the selection configuration may be received (e.g., at 832) via a dedicated signaling.

In some aspects, at 1206, the UE may determine the content selection criterion based on information of the UE. The information of the UE may include one or more of: first information related to an application associated with the UE, second information related to a network associated with the UE, or a radio condition. For example, referring to FIG. 8, the UE 802 may, at 834, determine the content selection criterion based on information of the UE 802. The information of the UE 802 may include one or more of: first information related to an application associated with the UE 802, second information related to a network associated with the UE 802, or a radio condition.

In some aspects, the information of the UE is based on an output of an AI/ML model associated with the UE. For example, referring to FIG. 8, the information of the UE 802 may be based on an output of an AI/ML model associated with the UE (e.g., model 840).

In some aspects, the AI/ML model may include one or more of: an internal model of the UE, a coordinated model between the UE and the network entity, or an application-based model. For example, referring to FIG. 8, the AI/ML model may include one or more of: an internal model of the UE 802, a coordinated model between the UE 802 and the network entity (e.g., base station 804), or an application-based model.

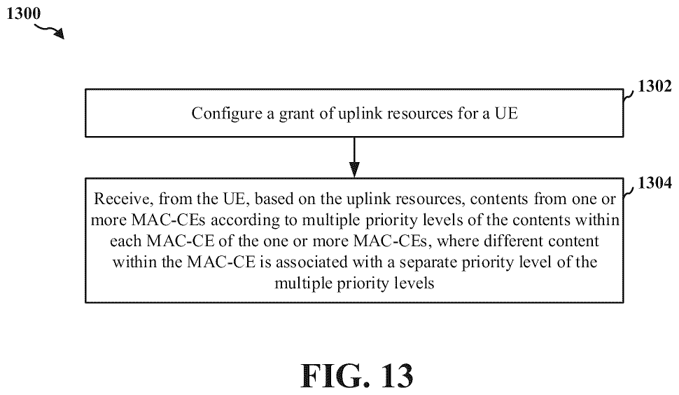

FIG. 13 is a flowchart 1300 illustrating methods of wireless communication at a network entity in accordance with various aspects of the present disclosure. The method may be performed by a network entity in collaboration with a UE. The network entity may be a base station, or a component of a base station, in the access network of FIG. 1 or a core network component (e.g., base station 102, 310, 804; or the network entity 1402 in the hardware implementation of FIG. 14). The UE may be the UE 104, 350, 802, or the apparatus 1404 in the hardware implementation of FIG. 14. By enabling content-based prioritization across different MAC-CEs, the methods ensure that high-priority contents from lower-priority MAC-CEs are not unnecessarily delayed and reduce the risk of missing important information in the MAC-CEs when transmission resources are limited. Additionally, by allowing MAC-CE prioritization to be configured through standards, signaling, or UE implementation, the methods provide flexibility in adapting prioritization strategies based on real-time network conditions and use cases. In some examples, by introducing multiple priority classes instead of relying solely on absolute priority order among the MAC-CEs, the methods improve scheduling efficiency, and the efficiency and timeliness of MAC-CE transmissions.

As shown in FIG. 13, at 1302, the network entity may configure a grant of uplink resources for a UE. FIG. 8 illustrates various aspects of the steps in connection with flowchart 1300. For example, referring to FIG. 8, the network entity (e.g., base station 804) may, at 810, configure a grant of uplink resources for a UE 802. In some aspects, 1302 may be performed by the prioritization component 199.

At 1304, the network entity may receive from the UE contents from one or more MAC-CEs according to multiple priority levels of the contents within each MAC-CE of the one or more MAC-CEs based on the uplink resources. Different content within the MAC-CE may be associated with a separate priority level of the multiple priority levels. For example, referring to FIG. 8, the network entity (e.g., base station 804) may, at 838, receive from the UE 802 contents from one or more MAC-CEs according to multiple priority levels of the contents within each MAC-CE of the one or more MAC-CEs based on the uplink resources. Referring to FIG. 6, the one or more MAC-CEs may include MAC-CE X 610 and MAC-CE Y 630. The multiple priority levels may include priority 1 and priority 2. Contents A 612, B 614, C 616 in MAC-CE X 610 and contents P 632, Q 634, R 636 in MAC-CE Y 630 may have priority 1. Contents D 618, E 620, F 622 in MAC-CE X 610 and contents S 638, T 640, U 642, V 644 in MAC-CE Y 630 may have priority 2. In some aspects, 1304 may be performed by the prioritization component 199.

In some aspects, the priority levels for the respective content of the MAC-CE may be based on one or more of LCG information of the respective content of the MAC-CE; service beam information of the respective content of the MAC-CE; or cell information of the respective content of the MAC-CE. For example, referring to FIG. 6, the priority levels (e.g., priority 1 or priority 2) for the respective content (contents A 612, B 614, C 616, D 618, E 620, F 622 in MAC-CE X 610, and contents P 632, Q 634, R 636, S 638, T 640, U 642, V 644 in MAC-CE Y 630) of the MAC-CE may be based on one or more of LCG information of the respective content of the MAC-CE; service beam information of the respective content of the MAC-CE; or cell information of the respective content of the MAC-CE.

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include at least one cellular baseband processor (or processing circuitry) 1424 (also referred to as a modem) coupled to one or more transceivers 1422 (e.g., cellular RF transceiver). The cellular baseband processor(s) (or processing circuitry) 1424 may include at least one on-chip memory (or memory circuitry) 1424′. In some aspects, the apparatus 1404 may further include one or more subscriber identity modules (SIM) cards 1420 and at least one application processor (or processing circuitry) 1406 coupled to a secure digital (SD) card 1408 and a screen 1410. The application processor(s) (or processing circuitry) 1406 may include on-chip memory (or memory circuitry) 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor(s) (or processing circuitry) 1424 communicates through the transceiver(s) 1422 via one or more antennas 1480 with the UE 104 and/or with an RU associated with a network entity 1402. The cellular baseband processor(s) (or processing circuitry) 1424 and the application processor(s) (or processing circuitry) 1406 may each include a computer-readable medium/memory (or memory circuitry) 1424′, 1406′, respectively. The additional memory modules 1426 may also be considered a computer-readable medium/memory (or memory circuitry). Each computer-readable medium/memory (or memory circuitry) 1424′, 1406′, 1426 may be non-transitory. The cellular baseband processor(s) (or processing circuitry) 1424 and the application processor(s) (or processing circuitry) 1406 are each responsible for general processing, including the execution of software stored on the computer-readable medium/memory (or memory circuitry). The software, when executed by the cellular baseband processor(s) (or processing circuitry) 1424/application processor(s) (or processing circuitry) 1406, causes the cellular baseband processor(s) (or processing circuitry) 1424/application processor(s) (or processing circuitry) 1406 to perform the various functions described supra. The cellular baseband processor(s) (or processing circuitry) 1424 and the application processor(s) (or processing circuitry) 1406 are configured to perform the various functions described supra based at least in part of the information stored in the memory (or memory circuitry). That is, the cellular baseband processor(s) (or processing circuitry) 1424 and the application processor(s) (or processing circuitry) 1406 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1424/application processor(s) (or processing circuitry) 1406 when executing software. The cellular baseband processor(s) (or processing circuitry) 1424/application processor(s) (or processing circuitry) 1406 may be a component of the UE 350 and may include the at least one memory 360 and/or at least one of the TX processor 368, the RX processor 356, and the controller/processor 359. In one configuration, the apparatus 1404 may be at least one processor chip (modem and/or application) and include just the cellular baseband processor(s) (or processing circuitry) 1424 and/or the application processor(s) (or processing circuitry) 1406, and in another configuration, the apparatus 1404 may be the entire UE (e.g., see UE 350 of FIG. 3) and include the additional modules of the apparatus 1404.

As discussed supra, in some aspects, the component 198 may be configured to receive a grant of uplink resources; prioritize, for each MAC-CE of one or more MAC-CEs, different portions of the MAC-CE based on respective content of respective portions of the MAC-CE, where different content within the MAC-CE is associated with a separate priority level; and transmit, to a network entity, based on the uplink resources and the priority levels of the different portions of each MAC-CE of the one or more MAC-CEs, the one or more MAC-CEs. In some aspects, the component 198 may be configured to receive a grant of uplink resources; prioritize multiple candidate MAC-CEs based on multiple priority classes; prioritize one or more candidate MAC-CEs within a priority class of the multiple priority classes; and transmit, to a network entity, based on the uplink resources and the multiple priority classes, one or more selected MAC-CEs from the one or more candidate MAC-CEs in the priority class. The component 198 may be further configured to perform any of the aspects described in connection with the flowcharts in FIG. 9, FIG. 10, FIG. 11, and FIG. 12 and/or performed by the UE 802 in FIG. 8. The component 198 may be within the cellular baseband processor(s) (or processing circuitry) 1424, the application processor(s) (or processing circuitry) 1406, or both the cellular baseband processor(s) (or processing circuitry) 1424 and the application processor(s) (or processing circuitry) 1406. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1404 may include a variety of components configured for various functions. In one configuration, the apparatus 1404, and in particular the cellular baseband processor(s) (or processing circuitry) 1424 and/or the application processor(s) (or processing circuitry) 1406, includes means for receiving a grant of uplink resources; means for prioritizing, for each MAC-CE of one or more MAC-CEs, different portions of the MAC-CE based on respective content of respective portions of the MAC-CE, where different content within the MAC-CE is associated with a separate priority level; and means for transmitting, to a network entity, based on the uplink resources and the priority levels of the different portions of each MAC-CE of the one or more MAC-CEs, the one or more MAC-CEs. In some configuration, the apparatus 1404, and in particular the cellular baseband processor(s) (or processing circuitry) 1424 and/or the application processor(s) (or processing circuitry) 1406, includes means for receiving a grant of uplink resources; means for prioritizing multiple candidate MAC-CEs based on multiple priority classes; means for prioritizing one or more candidate MAC-CEs within a priority class of the multiple priority classes; and means for transmitting, to a network entity, based on the uplink resources and the multiple priority classes, one or more selected MAC-CEs from the one or more candidate MAC-CEs in the priority class. The apparatus 1404 may further include means for performing any of the aspects described in connection with the flowcharts in FIG. 9, FIG. 10, FIG. 11, and FIG. 12, and/or aspects performed by the UE 802 in FIG. 8. The means may be the component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

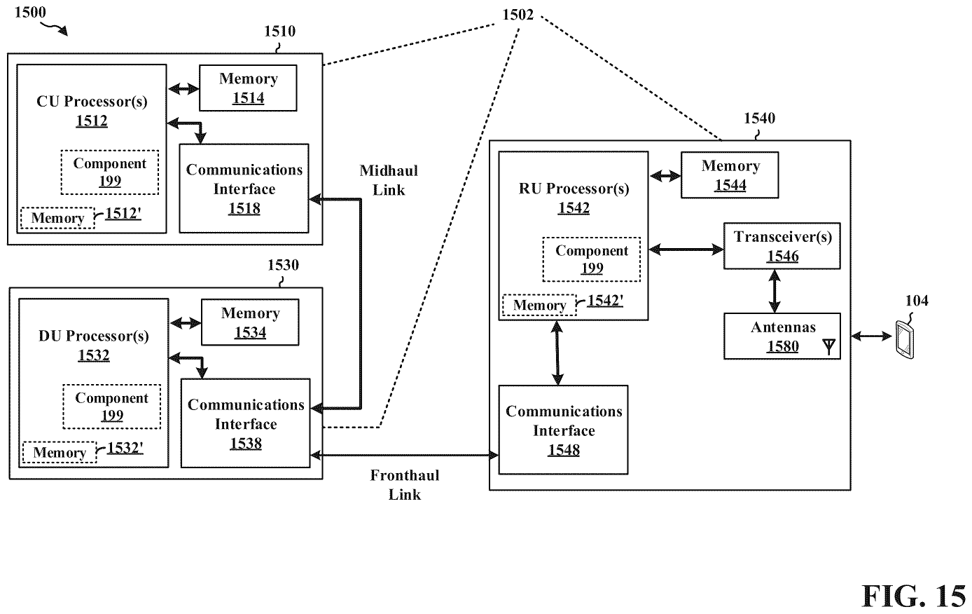

FIG. 15 is a diagram 1500 illustrating an example of a hardware implementation for a network entity 1502. The network entity 1502 may be a BS, a component of a BS, or may implement BS functionality. The network entity 1502 may include at least one of a CU 1510, a DU 1530, or an RU 1540. For example, depending on the layer functionality handled by the component 199, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include at least one CU processor (or processing circuitry) 1512. The CU processor(s) (or processing circuitry) 1512 may include on-chip memory (or memory circuitry) 1512′. In some aspects, the CU 1510 may further include additional memory modules 1514 and a communications interface 1518. The CU 1510 communicates with the DU 1530 through a midhaul link, such as an F1 interface. The DU 1530 may include at least one DU processor (or processing circuitry) 1532. The DU processor(s) (or processing circuitry) 1532 may include on-chip memory (or memory circuitry) 1532′. In some aspects, the DU 1530 may further include additional memory modules 1534 and a communications interface 1538. The DU 1530 communicates with the RU 1540 through a fronthaul link. The RU 1540 may include at least one RU processor (or processing circuitry) 1542. The RU processor(s) (or processing circuitry) 1542 may include on-chip memory (or memory circuitry) 1542′. In some aspects, the RU 1540 may further include additional memory modules 1544, one or more transceivers 1546, antennas 1580, and a communications interface 1548. The RU 1540 communicates with the UE 104. The on-chip memory (or memory circuitry) 1512′, 1532′, 1542′ and the additional memory modules 1514, 1534, 1544 may each be considered a computer-readable medium/memory (or memory circuitry). Each computer-readable medium/memory (or memory circuitry) may be non-transitory. Each of the processors (or processing circuitry) 1512, 1532, 1542 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to configure a grant of uplink resources for a UE; and receive, from the UE, based on the uplink resources, contents from one or more MAC-CEs according to multiple priority levels of the contents within each MAC-CE of the one or more MAC-CEs, where different content within the MAC-CE is associated with a separate priority level of the multiple priority levels. The component 199 may be further configured to perform any of the aspects described in connection with the flowchart in FIG. 13, and/or performed by the base station 804 in FIG. 8. The component 199 may be within one or more processors (or processing circuitry) of one or more of the CU 1510, DU 1530, and the RU 1540. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1502 may include a variety of components configured for various functions. In one configuration, the network entity 1502 includes means for configuring a grant of uplink resources for a UE; and means for receiving, from the UE, based on the uplink resources, contents from one or more MAC-CEs according to multiple priority levels of the contents within each MAC-CE of the one or more MAC-CEs, where different content within the MAC-CE is associated with a separate priority level of the multiple priority levels. The network entity 1502 may further include means for performing any of the aspects described in connection with the flowchart in FIG. 13, and/or aspects performed by the base station 804 in FIG. 8. The means may be the component 199 of the network entity 1502 configured to perform the functions recited by the means. As described supra, the network entity 1502 may include the TX processor 316, the RX processor 370, and the controller/processor 375. As such, in one configuration, the means may be the TX processor 316, the RX processor 370, and/or the controller/processor 375 configured to perform the functions recited by the means. Some aspects and techniques as described herein may be implemented, at least in part, using an artificial intelligence (AI) program, such as a program that includes a machine learning (ML) or artificial neural network (ANN) model. An example ML model may include mathematical representations or define computing capabilities for making inferences from input data based on patterns or relationships identified in the input data. As used herein, the term “inferences” can include one or more of decisions, predictions, determinations, or values, which may represent outputs of the ML model. The computing capabilities may be defined in terms of certain parameters of the ML model, such as weights and biases. Weights may indicate relationships between certain input data and certain outputs of the ML model, and biases are offsets which may indicate a starting point for outputs of the ML model. An example ML model operating on input data may start at an initial output based on the biases and then update its output based on a combination of the input data and the weights.

In some aspects, an ML model may be configured to provide computing capabilities for wireless communications. Such an ML model may be configured with weights and biases to identify priorities among various content within MAC-CEs and/or to prioritize between content across multiple MAC-CEs, e.g., as described herein Thus, during operation of a device, the ML model may receive input data (such as information about content triggered for transmission in MAC-CEs and may output priorities for the content and/or selected content for transmission based on the weights and biases.

ML models may be deployed in one or more devices (for example, network entities and user equipments (UEs)) and may be configured to enhance various aspects of a wireless communication system. For example, an ML model may be trained to identify patterns or relationships in data corresponding to a network, a device, an air interface, or the like. An ML model may support operational decisions relating to one or more aspects associated with wireless communications devices, networks, or services. For example, an ML model may be utilized for supporting or improving aspects such as signal coding/decoding, prioritization, MAC-CE generation, MAC-CE content selection, determination of priority levels for MAC-CE content, network routing, energy conservation, transceiver circuitry controls, frequency synchronization, timing synchronization, channel state estimation, channel equalization, channel state feedback, modulation, demodulation, device positioning, beamforming, load balancing, operations and management functions, security, etc. ML models may be characterized in terms of types of learning that generate specific types of learned models that perform specific types of tasks. For example, different types of machine learning include supervised learning, unsupervised learning, semi-supervised learning, reinforcement learning, etc. ML models may be used to perform different tasks such as classification or regression, where classification refers to determining one or more discrete output values from a set of predefined output values, and regression refers to determining continuous values which are not bounded by predefined output values. For example, a classification ML model configured according to aspects of this disclosure may produce an output which includes a priority level for each of various types of MAC-CE content or a selection of a sub-set of MAC-CE content to be transmitted among multiple triggered MAC-CEs based on content level prioritization. A regression ML model configured according to embodiments of this disclosure may produce an output which includes priorities for the content and/or selected content for transmission, among other examples. Some example ML models configured for performing such tasks include ANNs such as convolutional neural networks (CNNs) and recurrent neural networks (RNNs), transformers, diffusion models, regression analysis models (such as statistical models), large language models (LLMs), decision tree learning (such as predictive models), support vector networks (SVMs), and probabilistic graphical models (such as a Bayesian network), etc. The model may assist a UE in truncating MAC-CEs when there is more MAC-CE information to be transmitted than resources allocated for the transmission.

The description herein illustrates, by way of some examples, how one or more tasks or problems in wireless communications may benefit from the application of one or more ML models The model may assist a UE in truncating MAC-CEs when there is more MAC-CE information to be transmitted than resources allocated for the transmission. To facilitate the discussion, an ML model configured using an ANN is used, but it should be understood, that other types of ML models may be used instead of an ANN. Hence, unless expressly recited, subject matter regarding an ML model is not necessarily intended to be limited to an ANN solution. Further, it should be understood that, unless otherwise specifically stated, terms such “AI/ML model,” “ML model,” “trained ML mode,” “ANN,” “model,” “algorithm,” or the like are intended to be interchangeable.

FIG. 16 is an illustrative block diagram of an example machine learning (ML) model represented by an artificial neural network (ANN) 1600. ANN 1600 may receive input data 1606 which may include one or more bits of data 1602, pre-processed data output from pre-processor 1604 (optional), or some combination thereof. Here, data 1602 may include training data, verification data, application-related data, or the like, based, for example, on the stage of deployment of ANN 1600. Pre-processor 1604 may be included within ANN 1600 in some other implementations. Pre-processor 1604 may, for example, process all or a portion of data 1602 which may result in some of data 1602 being changed, replaced, deleted, etc. In some implementations, pre-processor 1604 may add additional data to data 1602. In some implementations, the pre-processor 1604 may be a ML model, such as an ANN.

The ANN 1600 includes at least one first layer 1608 of artificial neurons 1610 to process input data 1606 and provide resulting first layer data via connections or “edges” such as edges 1612 to at least a portion of at least one second layer 1614. Second layer 1614 processes data received via edges 1612 and provides second layer output data via edges 1616 to at least a portion of at least one third layer 1618. Third layer 1618 processes data received via edges 1616 and provides third layer output data via edges 1620 to at least a portion of a final layer 1622 including one or more neurons to provide output data 1624. All or part of output data 1624 may be further processed in some manner by (optional) post-processor 1626. Thus, in certain examples, ANN 1600 may provide output data 1628 that is based on output data 1624, post-processed data output from post-processor 1626, or some combination thereof.

Post-processor 1626 may be included within ANN 1600 in some other implementations. Post-processor 1626 may, for example, process all or a portion of output data 1624 which may result in output data 1628 being different, at least in part, to output data 1624, as result of data being changed, replaced, deleted, etc. In some implementations, post-processor 1626 may be configured to add additional data to output data 1624. In this example, second layer 1614 and third layer 1618 represent intermediate or hidden layers that may be arranged in a hierarchical or other like structure. Although not explicitly shown, there may be one or more further intermediate layers between the second layer 1614 and the third layer 1618. In some implementations, the post-processor 1626 may be a ML model, such as an ANN. The structure and training of artificial neurons 1610 in the various layers may be tailored to specific requirements of an application. Within a given layer such as first layer 1608, second layer 1614, or third layer 1618 of ANN 1600, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to parameters such as the previously described weights and biases of ANN 1600. The weights and biases of ANN 1600 may be adjusted during a training process or during operation of ANN 1600. The weights of the various artificial neurons may control a strength of connections between layers or artificial neurons, while the biases may control a direction of connections between the layers or artificial neurons. An activation function may select or determine whether an artificial neuron transmits its output to the next layer or not in response to its received data.

Different activation functions may be used to model different types of non-linear relationships. By introducing non-linearity into an ML model, an activation function allows the configuration for the ML model to change in response to identifying or detecting complex patterns and relationships in the input data 1606 (e.g., MAC-CE contents). Some non-exhaustive example activation functions include a sigmoid based activation function, a hyperbolic tangent (tanh) based activation function, a convolutional activation function, up-sampling, pooling, and a rectified linear unit (ReLU) based activation function.

Training of an ML model, such as ANN 1600, may be conducted using training data. Training data may include one or more datasets which ANN 1600 may use to identify patterns or relationships. Training data may represent various types of information, including written, visual, audio, environmental context, operational properties, etc. During training, the parameters (such as the weights and biases) of artificial neurons 1610 may be changed, such as to minimize or otherwise reduce a loss function or a cost function. A training process may be repeated multiple times to fine-tune ANN 1600 with each iteration.

Various ANN model structures are available for consideration. For example, in a feedforward ANN structure, each artificial neuron 1610 in layer 1614 receives information from the previous layer (such as, one or more artificial neurons 1610 in layer 1608) and produces information for the next layer (such as, one or more artificial neurons 1610 in layer 1618). In a convolutional ANN structure, some layers may be organized into filters that extract features from data, such as the training data or the input data. In a recurrent ANN structure, some layers may have connections that allow for processing of data across time, such as for processing information having a temporal structure, such as time series data forecasting.

In an autoencoder ANN structure, compact representations of data may be processed and the model trained to predict or potentially reconstruct original data from a reduced set of features. An autoencoder ANN structure may be useful for tasks related to dimensionality reduction and data compression.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute weighted sums of input features based on a similarity between different elements of the input sequence. A transformer ANN structure may include a series of feedforward ANN layers whose configurations may change in response to identifying non-linear relationships between the input and output sequences, which may also be referred to as a process of “learning” by the ANN layers. The output of a transformer ANN structure may be obtained by applying a linear transformation to the output of a final attention layer. A transformer ANN structure may be of particular use for tasks that involve sequence modeling, or other like processing.

Another example type of ANN structure is a model with one or more invertible layers. Models of this type may be inverted or “unwrapped” to reveal the input data that was used to generate the output of a layer. Other example types of ANN model structures include fully connected neural networks (FCNNs) and long short-term memory (LSTM) networks.

ANN 1600 or other ML models may be implemented in various types of processing circuits along with memory and applicable instructions therein. For example, general-purpose hardware circuits, such as, such as one or more central processing units (CPUs), one or more graphics processing units (GPUs), or suitable combinations thereof, may be employed to implement a model. In some implementations, one or more tensor processing units (TPUs), neural processing units (NPUs), or other special-purpose processors, field-programmable gate arrays (FPGAs), application-specific integrated circuits (ASICs), or the like may also be employed. In some implementations, the ML model may be implemented by a NPU or a TPU embedded in a system on chip (SoC) along with other components, such as one or more CPUs, GPUs, etc. A SoC includes several components manufactured on a shared semiconductor substrate. The NPU or TPU may be controlled by the one or more CPUs by configuring the ML model implemented by the NPU or TPU with weights and biases, providing certain training data to the ML model to configure the ML model, or providing input data to the ML model to obtain related inferences. The one or more CPUs may also receive the inferences and be configured to perform certain actions based on the inferences produced by the ML model. The actions performed by the one or more CPUs may include sending commands to other components of the SoC or components external to the SoC to perform certain actions. For example, the CPU may send commands to a RF transceiver based on the outputs or inferences obtained from an ML model to cause the RF transceiver to operate on a wireless network in accordance with the ML model.

This disclosure provides a method for wireless communication at a UE. The method may include receiving a grant of uplink resources; prioritizing, for each MAC-CE of one or more MAC-CEs, different portions of the MAC-CE based on respective content of respective portions of the MAC-CE, where different content within the MAC-CE is associated with a separate priority level; and transmitting the one or more MAC-CEs to a network entity based on the uplink resources and the priority levels of the different portions of each MAC-CE of the one or more MAC-CEs. By enabling content-based prioritization across different MAC-CEs, the methods ensure that high-priority contents from lower-priority MAC-CEs are not unnecessarily delayed and reduce the risk of missing important information in the MAC-CEs when transmission resources are limited. Additionally, by allowing MAC-CE prioritization to be configured through standards, signaling, or UE implementation, the methods provide flexibility in adapting prioritization strategies based on real-time network conditions and use cases. In some examples, by introducing multiple priority classes instead of relying solely on absolute priority order among the MAC-CEs, the methods improve scheduling efficiency, and the efficiency and timeliness of MAC-CE transmissions.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processor P) is configured to perform a set of functions F, each processor of P may be configured to perform a subset S of F, where S E F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), the method includes receiving a grant of uplink resources; prioritizing, for each medium access control-control element (MAC-CE) of one or more MAC-CEs, different portions of the MAC-CE based on respective content of respective portions of the MAC-CE, wherein different content within the MAC-CE is associated with a separate priority level; and transmitting, to a network entity, based on the uplink resources and the priority levels of the different portions of each MAC-CE the one or more MAC-CEs, the one or more MAC-CEs.

Aspect 2 is the method of aspect 1, wherein priority levels for the respective content of the MAC-CE are based on one or more of logic channel group (LCG) information of the respective content of the MAC-CE; service beam information of the respective content of the MAC-CE; or cell information of the respective content of the MAC-CE.

Aspect 3 is the method of any of aspects 1 to 2, wherein transmitting the one or more MAC-CEs includes transmitting a combination of a first selected content from a first MAC-CE in the one or more MAC-CEs and a second selected content from a second MAC-CE in the one or more MAC-CEs, wherein the first selected content is selected from first MAC contents of the first MAC-CE; the second selected content is selected from second MAC contents of the second MAC-CE; the first MAC contents and the second MAC contents are respectively associated with at least one priority level of multiple priority levels; and wherein the combination of the first selected content and the second selected content is based on the multiple priority levels.

Aspect 4 is the method of aspect 3, where the method further includes encoding, based on the uplink resources, the combination of the first selected content and the second selected content to obtain a MAC transport block (MAC-TB), wherein transmitting the combination of the first selected content and the second selected content comprises transmitting the MAC-TB.

Aspect 5 is the method of aspect 4, wherein the uplink resources have a resource size exceeding a transmission size for transmitting the first MAC-CE and the second MAC-CE; and wherein the first selected content includes the first MAC contents; and the second selected content includes the second MAC contents.

Aspect 6 is the method of aspect 4, wherein the uplink resources have a resource size less than a transmission size for transmitting the first MAC-CE and the second MAC-CE; and wherein the method further comprises selecting, based on the multiple priority levels, the first selected content and the second selected content respectively from the first MAC contents and the second MAC contents.

Aspect 7 is the method of aspect 6, wherein selecting the first selected content and the second selected content respectively from the first MAC contents and the second MAC contents comprises selecting, based on the resource size and a descending order of priority levels of the first MAC contents and the second MAC contents, the first selected content and the second selected content respectively from the first MAC contents and the second MAC contents, wherein contents with a higher priority level is selected before the contents of a lower priority level.

Aspect 8 is the method of aspect 7, wherein the first MAC contents include the first selected content and a first unselected content; the second MAC contents include the second selected content and a second unselected content; wherein the first selected content and the second selected content are associated with a first priority level of the multiple priority levels; and the first unselected content and the second unselected content are associated with a second priority level of the multiple priority levels, wherein the second priority level is lower than the first priority level.

Aspect 9 is an apparatus for wireless communication at a UE, comprising: at least one memory; and at least one processor coupled to the at least one memory, the at least one processor is configured to perform the method of any of aspects 1 to 8.

Aspect 10 is the apparatus for wireless communication at a UE, comprising means for performing each step in the method of any of aspects 1-8.

Aspect 11 is an apparatus of any of aspects 9-10, further comprising a transceiver configured to receive or to transmit in association with the method of any of aspects 1-8.

Aspect 12 is a computer-readable medium (e.g., a non-transitory computer-readable medium) storing computer executable code at a UE, the code when executed by at least one processor causes the at least one processor to perform the method of any of aspects 1-8.

Aspect 13 is a method of wireless communication at a user equipment (UE), the method includes receiving a grant of uplink resources; prioritizing multiple candidate medium access control-control elements (MAC-CEs) based on multiple priority classes; prioritizing one or more candidate MAC-CEs within a priority class of the multiple priority classes; and transmitting, to a network entity, based on the uplink resources and the multiple priority classes, one or more selected MAC-CEs from the one or more candidate MAC-CEs in the priority class.

Aspect 14 is the method of aspect 13, wherein each candidate MAC-CE is associated with one priority class of the multiple priority classes; wherein the one or more selected MAC-CEs are selected from the one or more candidate MAC-CEs in the priority class based on MAC contents of the one or more candidate MAC-CEs.

Aspect 15 is the method of any of aspects 13 to 14, wherein the MAC content of the MAC-CEs includes one or more of identifier information; control signaling information; recovery and failure information; timing and synchronization information; positioning information; measurement information; or power control information.

Aspect 16 is the method of any of aspects 13 to 15, wherein prioritizing the multiple candidate MAC-CEs based on the multiple priority classes includes selecting, based on a descending order of the priority classes of the multiple candidate MAC-CEs in the multiple priority classes, a first set of MAC-CEs from the multiple candidate MAC-CEs; and wherein prioritizing the one or more candidate MAC-CEs within the priority class of the multiple priority classes includes selecting, based on a content selection criterion, the one or more selected MAC-CEs from the first set of MAC-CEs.

Aspect 17 is the method of aspect 16, wherein the content selection criterion is based on a defined rule.

Aspect 18 is the method of aspect 16, where the method further includes receiving, from the network entity, a selection configuration indicative of the content selection criterion.

Aspect 19 is the method of aspect 18, wherein the selection configuration is received via a common signaling.

Aspect 20 is the method of aspect 18, wherein the selection configuration is received via a dedicated signaling.

Aspect 21 is the method of aspect 16, where the method further includes determining the content selection criterion based on information of the UE, wherein the information of the UE comprises one or more of first information related to an application associated with the UE; second information related to a network associated with the UE; or a radio condition.

Aspect 22 is the method of aspect 21, wherein the information of the UE is based on an output of an artificial intelligence/machine learning (AI/ML) model associated with the UE.

Aspect 23 is the method of aspect 22, wherein the AI/ML model includes one or more of an internal model of the UE; a coordinated model between the UE and the network entity; or an application-based model.

Aspect 24 is the method of aspect 13, where the method further includes encoding the one or more selected MAC-CEs to obtain a MAC transport block (MAC-TB), wherein transmitting the one or more selected MAC-CEs comprises transmitting the MAC-TB.

Aspect 25 is an apparatus for wireless communication at a UE, comprising: at least one memory; and at least one processor coupled to the at least one memory and, where the at least one processor is configured to perform the method of any of aspects 13-24.

Aspect 26 is the apparatus for wireless communication at a UE, comprising means for performing each step in the method of any of aspects 13-24.

Aspect 27 is an apparatus of any of aspects 25-26, further comprising a transceiver configured to receive or to transmit in association with the method of any of aspects 13-24.

Aspect 28 is a computer-readable medium (e.g., a non-transitory computer-readable medium) storing computer executable code at a UE, the code when executed by at least one processor causes the at least one processor to perform the method of any of aspects 13-24.

Aspect 29 is a method of wireless communication at a network entity, the method includes configuring a grant of uplink resources for a user equipment (UE); and receiving, from the UE, based on the uplink resources, contents from one or more medium access control-control elements (MAC-CEs) according to multiple priority levels of the contents within each MAC-CE of the one or more MAC-CEs, wherein different content within the MAC-CE is associated with a separate priority level of the multiple priority levels.

Aspect 30 is the method of aspect 29, wherein priority levels for the respective content of the MAC-CE are based on one or more of logic channel group (LCG) information of the respective content of the MAC-CE; service beam information of the respective content of the MAC-CE; or cell information of the respective content of the MAC-CE.

Aspect 31 is an apparatus for wireless communication at a network entity, comprising: at least one memory; and at least one processor coupled to the at least one memory and, where the at least one processor is configured to perform the method of any of aspects 29-30.

Aspect 32 is the apparatus for wireless communication at a network entity, comprising means for performing each step in the method of any of aspects 29-30.

Aspect 33 is an apparatus of any of aspects 31-32, further comprising a transceiver configured to receive or to transmit in association with the method of any of aspects 29-30.

Aspect 34 is a computer-readable medium (e.g., a non-transitory computer-readable medium) storing computer executable code at a network entity, the code when executed by at least one processor causes the at least one processor to perform the method of any of aspects 29-30.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
receive a grant of uplink resources;
prioritize, for each medium access control-control element (MAC-CE) of one or more MAC-CEs, different portions of the MAC-CE based on respective content of respective portions of the MAC-CE, wherein different content within the MAC-CE is associated with a separate priority level; and
transmit, to a network entity, based on the uplink resources and priority levels of the different portions of each MAC-CE of the one or more MAC-CEs, the one or more MAC-CEs.

2. The apparatus of claim 1, further comprising a transceiver coupled to the at least one processor, wherein to transmit the one or more MAC-CEs, the at least one processor is configured to transmit the one or more MAC-CEs via the transceiver, and wherein the priority levels for the respective content of the MAC-CE are based on one or more of:
logic channel group (LCG) information of the respective content of the MAC-CE,
service beam information of the respective content of the MAC-CE, or
cell information of the respective content of the MAC-CE.

3. The apparatus of claim 1, wherein to transmit the one or more MAC-CEs, the at least one processor is configured to:
transmit a combination of a first selected content from a first MAC-CE in the one or more MAC-CEs and a second selected content from a second MAC-CE in the one or more MAC-CEs, wherein the first selected content is selected from first MAC contents of the first MAC-CE, the second selected content is selected from second MAC contents of the second MAC-CE, the first MAC contents and the second MAC contents are respectively associated with at least one priority level of multiple priority levels, and wherein the combination of the first selected content and the second selected content is based on the multiple priority levels.

4. The apparatus of claim 3, wherein the at least one processor is further configured to:
encode, based on the uplink resources, the combination of the first selected content and the second selected content to obtain a MAC transport block (MAC-TB), wherein to transmit the combination of the first selected content and the second selected content, the at least one processor is configured to:
transmit the MAC-TB.

5. The apparatus of claim 4, wherein the uplink resources have a resource size exceeding a transmission size for transmitting the first MAC-CE and the second MAC-CE, and wherein the first selected content includes the first MAC contents, and the second selected content includes the second MAC contents.

6. The apparatus of claim 4, wherein the uplink resources have a resource size less than a transmission size for transmitting the first MAC-CE and the second MAC-CE, and wherein the at least one processor is further configured to:
select, based on the multiple priority levels, the first selected content and the second selected content respectively from the first MAC contents and the second MAC contents.

7. The apparatus of claim 6, wherein to select the first selected content and the second selected content respectively from the first MAC contents and the second MAC contents, the at least one processor is configured to:
select, based on the resource size and a descending order of the priority levels of the first MAC contents and the second MAC contents, the first selected content and the second selected content respectively from the first MAC contents and the second MAC contents, wherein contents with a higher priority level is selected before the contents of a lower priority level.

8. The apparatus of claim 7, wherein the first MAC contents include the first selected content and a first unselected content, the second MAC contents include the second selected content and a second unselected content, wherein the first selected content and the second selected content are associated with a first priority level of the multiple priority levels, and the first unselected content and the second unselected content are associated with a second priority level of the multiple priority levels, wherein the second priority level is lower than the first priority level.

9. An apparatus for wireless communication at a user equipment (UE), comprising:
at least one memory; and
at least one processor coupled to the at least one memory and, based at least in part on stored information that is stored in the at least one memory, the at least one processor is configured to:
receive a grant of uplink resources;
prioritize multiple candidate medium access control-control elements (MAC-CEs) based on multiple priority classes;
prioritize one or more candidate MAC-CEs within a priority class of the multiple priority classes; and
transmit, to a network entity, based on the uplink resources and the multiple priority classes, one or more selected MAC-CEs from the one or more candidate MAC-CEs in the priority class.

10. The apparatus of claim 9, further comprising a transceiver coupled to the at least one processor, wherein to transmit the one or more selected MAC-CEs, the at least one processor is configured to transmit the one or more selected MAC-CEs via the transceiver, wherein each candidate MAC-CE is associated with one priority class of the multiple priority classes, and wherein the one or more selected MAC-CEs are selected from the one or more candidate MAC-CEs in the priority class based on MAC contents of the one or more candidate MAC-CEs.

11. The apparatus of claim 10, wherein the MAC contents of the one or more candidate MAC-CEs includes one or more of:
identifier information for the UE,
control signaling information for the UE,
recovery and failure information for the UE,
timing and synchronization information for the UE,
positioning information for the UE,
measurement information for the UE, or
power control information for the UE.

12. The apparatus of claim 9, wherein to prioritize the multiple candidate MAC-CEs based on the multiple priority classes, the at least one processor is configured to:
select, based on a descending order of priority classes of the multiple candidate MAC-CEs in the multiple priority classes, a first set of MAC-CEs from the multiple candidate MAC-CEs, and wherein to prioritize the one or more candidate MAC-CEs within the priority class of the multiple priority classes, the at least one processor is configured to:
select, based on a content selection criterion, the one or more selected MAC-CEs from the first set of MAC-CEs.

13. The apparatus of claim 12, wherein the content selection criterion is based on a defined rule.

14. The apparatus of claim 12, wherein the at least one processor is further configured to:
receive, from the network entity, a selection configuration indicative of the content selection criterion.

15. The apparatus of claim 14, wherein the selection configuration is received via a common signaling.

16. The apparatus of claim 14, wherein the selection configuration is received via a dedicated signaling.

17. The apparatus of claim 12, wherein the at least one processor is further configured to:
determine the content selection criterion based on information of the UE, wherein the information of the UE comprises one or more of:
first information related to an application associated with the UE,
second information related to a network associated with the UE, or
a radio condition.

18. The apparatus of claim 17, wherein the information of the UE is based on an output of an artificial intelligence/machine learning (AI/ML) model associated with the UE.

19. The apparatus of claim 18, wherein the AI/ML model includes one or more of:
an internal model of the UE,
a coordinated model between the UE and the network entity, or
an application-based model.

20. An apparatus for wireless communication at a network entity, comprising:
at least one memory; and
at least one processor coupled to the at least one memory and, based at least in part on information stored in the at least one memory, the at least one processor is configured to:
configure a grant of uplink resources for a user equipment (UE); and
receive, from the UE, based on the uplink resources, contents from one or more medium access control-control elements (MAC-CEs) according to multiple priority levels of the contents within each MAC-CE of the one or more MAC-CEs, wherein different content within at least one of the one or more MAC-CEs is associated with a separate priority level of the multiple priority levels.
